(19) United States
(12) Patent Application Publication
(10) Pub. No.: US 2019/0369424 A1
(43) Pub. Date: Dec. 5, 2019

(54) LIQUID CRYSTAL DISPLAY DEVICE

(71) Applicant: SHARP KABUSHIKI KAISHA, Osaka (JP)

(72) Inventor: SHINICHI HIRATO, Osaka (JP)

(21) Appl. No.: 16/431,230

(22) Filed: Jun. 4, 2019

Related U.S. Application Data
(60) Provisional application No. 62/680,672, filed on Jun. 5, 2018.

(51) Int. Cl. G02F 1/1337; G02F 1/1343; G02F 1/1335; G02F 1/1339

(52) U.S. Cl. CPC G02F 1/1337; G02F 1/134309; G02F 1/133528; G02F 1/13439; G02F 1/1368; G02F 1/133512; G02F 2001/133742; G02F 2001/134318; G02F 1/13394

(57) ABSTRACT

The present invention provides a liquid crystal display device capable of reducing leakage between a pair of substrates and increasing the rise response speed upon voltage application. The liquid crystal display device includes: a first substrate; a second substrate facing the first substrate; and a vertical alignment-type liquid crystal layer held between the first substrate and the second substrate, the first substrate including a pixel electrode, the second substrate including a projection, a common electrode covering the projection, and an insulating layer on the common electrode, the insulating layer superposed with a tip of the projection but not superposed with a side surface of the projection.

### CROSS-REFERENCE TO RELATED APPLICATIONS

The present application claims priority under 35 U.S.C. 5119 to U.S. Provisional Patent Application No. 62/680,672 filed on Jun. 5, 2018, the contents of which are incorporated herein by reference in their entirety.

### BACKGROUND OF THE INVENTION

### Field of the Invention

The present invention relates to liquid crystal display devices. More specifically, the present invention relates to a liquid crystal display device including a vertical alignment-type liquid crystal layer.

### Description of Related Art

Liquid crystal display devices utilize a liquid crystal composition to provide display. A typical display method therefor includes applying voltage to a liquid crystal composition sealed between a pair of substrates to change the alignment of the liquid crystal molecules (liquid crystal compounds) in the liquid crystal composition in response to the applied voltage, thereby controlling the amount of light transmitted through the liquid crystal display device. Such liquid crystal display devices are used in a wide range of applications owing to their features such as a thin profile, a light weight, and low power consumption.

Liquid crystal display devices are in a display mode such as a horizontal alignment mode or a vertical alignment mode. The horizontal alignment mode aligns liquid crystal molecules in a direction substantially parallel to a main surface of a substrate with no voltage applied, and examples thereof include the in-plane switching (IPS) mode and the fringe field switching (FFS) mode. The vertical alignment mode aligns liquid crystal molecules in a direction substantially perpendicular to a main surface of a substrate with no voltage applied, and examples thereof include the vertical alignment (VA) mode.

VA mode liquid crystal display devices provide display using a vertical alignment-type liquid crystal layer disposed between a pair of electrodes. A VA mode liquid crystal display device drawing particular attention owing to the favorable viewing angle characteristics is a multi-domain vertical alignment (MVA) mode liquid crystal display device, which aligns liquid crystal molecules in one pixel in different directions with voltage applied.

The MVA mode liquid crystal display device utilizes, for example, ribs formed on a substrate and slits formed in an electrode to align liquid crystal molecules in some different directions with voltage applied. Examples of such a rib-slit type MVA mode liquid crystal display device include the liquid crystal display device disclosed in JP 2010-271739 A, for example. The liquid crystal display device includes a first substrate (lower substrate) having a plurality of pixel areas; at least one pair of first and second protrusions formed at each pixel area; a pixel electrode formed at each pixel area, the pixel electrode having an opening pattern exposing the first protrusion while covering the second protrusion; a second substrate (upper substrate) facing the first substrate; and a common electrode formed at the second substrate. Also, WO 2008/53615 discloses a MVA mode liquid crystal display device including a stripe-shaped rib provided on a first electrode and a stripe-shaped slit formed in a second electrode. The rib has a side face whose taper angle in a cross section which is orthogonal to an azimuth direction that the rib extends is 18° or less, and is made of a material such that a film of the material with a thickness corresponding to a height of the rib has an OD value of 0.8 or more.

### BRIEF SUMMARY OF THE INVENTION

In the liquid crystal display device disclosed in JP 2010-271739 A, however, the pixel electrode over the tip of the second protrusion at the lower substrate may come close to the common electrode at the upper substrate to cause leakage between the substrates (hereinafter, the leakage is also referred to as vertical leakage).

Also, as in the liquid crystal display device disclosed in WO 2008/53615, a MVA mode liquid crystal display device including a pair of substrates one of which is provided with ribs and the other with slits may cause alignment disorder (back flow) of liquid crystal molecules to decrease the rise response speed, when the applied voltage is changed from the black voltage (no voltage applied) to a high voltage (e.g., the applied voltage is changed from the black voltage (no voltage applied) to a voltage giving a grayscale value of 240 or higher, with the voltage giving a grayscale value of 255 being defined as the white voltage). This is presumably for the following reason.

FIG. 27 is a schematic cross-sectional view of a MVA mode liquid crystal display device of Comparative Embodiment 1 including a pair of substrates one of which is provided with ribs and the other with slits. As shown in FIG. 27, a liquid crystal display device 1R of Comparative Embodiment 1 includes a first substrate 10R, a second substrate 20R facing the first substrate 10R, and a vertical alignment-type liquid crystal layer 30R held between the first substrate 10R and the second substrate 20R. The first substrate 10R includes pixel electrodes 12R each provided with slits SR. The second substrate 20R includes a common electrode 22R and projections TR formed on the common electrode 22R in the given order toward the liquid crystal layer 30R. The liquid crystal layer 30R contains liquid crystal molecules 31R having negative anisotropy of dielectric constant.

The liquid crystal display device 1R of Comparative Embodiment 1 can determine the alignment direction of the liquid crystal molecules 31R at an interface of the liquid crystal layer 30R using the projections TR formed on the common electrode 22R. However, the projections TR themselves cannot control electric fields E with voltage applied. This may cause alignment disorder (back flow) of the liquid crystal molecules 31R upon voltage application, decreasing the rise response speed.

In response to the above issues, an object of the present invention is to provide a liquid crystal display device capable of reducing leakage between a pair of substrates and increasing the rise response speed upon voltage application.

The present inventor made various studies on liquid crystal display devices capable of reducing vertical leakage and increasing the rise response speed upon voltage application. The studies found a technique of forming projections and a common electrode covering at least the side surface of each projection on the second substrate facing the first substrate including the pixel electrodes. This technique enables effective generation of oblique electric fields near the side surfaces of the projections upon voltage application, tilting the liquid crystal molecules easily. The inventor also found a technique of disposing insulating layers on the common electrode at the positions superposed with the tips of the projections and/or forming openings in the common electrode, for example, so that the common electrode does not cover the tips of the projections. This technique can reduce the chances for the common electrode on the second substrate to come into contact with a conductive part (e.g., pixel electrode) on the first substrate. The inventor thereby achieved the above object, completing the present invention.

(1) An embodiment of the present invention is directed to a liquid crystal display device including: a first substrate; a second substrate facing the first substrate; and a vertical alignment-type liquid crystal layer held between the first substrate and the second substrate, the first substrate including a pixel electrode, the second substrate including a projection, a common electrode covering the projection, and an insulating layer on the common electrode, the insulating layer superposed with a tip of the projection but not superposed with a side surface of the projection.

(2) In an embodiment of the present invention, the liquid crystal display device includes the structure (1), and the insulating layer has a thickness of 0.1 μm to 1.5 μm.

(3) Another embodiment of the present invention is directed to a liquid crystal display device including: a first substrate; a second substrate facing the first substrate; and a vertical alignment-type liquid crystal layer held between the first substrate and the second substrate, the first substrate including a pixel electrode, the second substrate including a projection and a common electrode covering a side surface of the projection but not covering a tip of the projection.

(4) In an embodiment of the present invention, the liquid crystal display device includes the structure (3), and the second substrate further includes a passivation film covering the projection and disposed between the projection and the common electrode.

(5) In an embodiment of the present invention, the liquid crystal display device includes any one of the structures (1), (2), (3), and (4), the projection is included in a projection structure, and the projection structure is not in contact with the first substrate at atmospheric pressure.

(6) In an embodiment of the present invention, the liquid crystal display device includes the structure (5) and further includes a polarizing plate on one or both of a side remote from the liquid crystal layer of the first substrate and a side remote from the liquid crystal layer of the second substrate, wherein the projection extends in a belt shape in a direction intersecting a polarization axis of the polarizing plate.

(7) In an embodiment of the present invention, the liquid crystal display device includes the structure (5), the pixel electrode includes at least one point symmetrical part, and the projection is dot-shaped and formed at a position facing a center of the point symmetrical part.

(8) In an embodiment of the present invention, the liquid crystal display device includes the structure (5), the projection structure is a sub spacer, and the projection is dot-shaped and formed in a light-shielding region.

(9) In an embodiment of the present invention, the liquid crystal display device includes any one of the structures (1), (2), (3), and (4), the projection is included in a projection structure, and the projection structure is in contact with the first substrate at atmospheric pressure.

(10) In an embodiment of the present invention, the liquid crystal display device includes the structure (9), the projection structure is a main spacer, and the projection is dot-shaped and formed in a light-shielding region.

The present invention can provide a liquid crystal display device capable of reducing leakage between a pair of substrates and increasing the rise response speed upon voltage application.

### BRIEF DESCRIPTION OF THE DRAWINGS

FIG. 1 is a schematic cross-sectional view of a liquid crystal display device of Embodiment 1.

FIG. 2A is a schematic plan view of display units in the liquid crystal display device of Embodiment 1.

FIG. 2B is an enlarged schematic plan view of a portion of a display unit in the liquid crystal display device of Embodiment 1, showing the region surrounded by a dashed-dotted circle in FIG. 2A.

FIG. 3 is a schematic cross-sectional view of a liquid crystal display device of Embodiment 2.

FIG. 4A is a schematic plan view of display units in the liquid crystal display device of Embodiment 2.

FIG. 4B is an enlarged schematic plan view of a portion of a display unit in the liquid crystal display device of Embodiment 2, showing the region surrounded by the dashed-dotted circle in FIG. 4A.

FIG. 5 is a schematic cross-sectional view of a liquid crystal display device of Embodiment 3.

FIG. 6A is a schematic plan view of display units in the liquid crystal display device of Embodiment 3.

FIG. 6B is a schematic plan view of the display units in the liquid crystal display device of Embodiment 3 with a focus on a first substrate.

FIG. 7 is a schematic cross-sectional view of a liquid crystal display device of Embodiment 4.

FIG. 8A is a schematic plan view of display units in the liquid crystal display device of Embodiment 4.

FIG. 8B is a schematic plan view of the display units in the liquid crystal display device of Embodiment 4 with a focus on a first substrate.

FIG. 9 is a schematic cross-sectional view of a liquid crystal display device of Embodiment 5.

FIG. 10A is a schematic plan view of display units in the liquid crystal display device of Embodiment 5.

FIG. 10B is a schematic plan view of the display units in the liquid crystal display device of Embodiment 5 with a focus on a first substrate.

FIG. 11 is a schematic cross-sectional view of a liquid crystal display device of Embodiment 6.

FIG. 12A is a schematic plan view of display units in the liquid crystal display device of Embodiment 6.

FIG. 12B is a schematic plan view of the display units in the liquid crystal display device of Embodiment 6 with a focus on a first substrate,

FIG. 13 is a schematic cross-sectional view of a liquid crystal display device of Embodiment 7.

FIG. 14A is a schematic plan view of display units in the liquid crystal display device of Embodiment 7.

FIG. 14B is a schematic plan view of the display units in the liquid crystal display device of Embodiment 7 with a focus on a first substrate.

FIG. 15 is a schematic cross-sectional view of a liquid crystal display device of Embodiment 8.

FIG. 16A is a schematic plan view of display units in the liquid crystal display device of Embodiment 8.

FIG. 16B is a schematic plan view of the display units in the liquid crystal display device of Embodiment 8 with a focus on a first substrate.

FIG. 17 is a schematic cross-sectional view of a liquid crystal display device of Example 1.

FIG. 18A is a schematic plan view of display units in the liquid crystal display device of Example 1.

FIG. 18B is an enlarged schematic plan view of the display units in the liquid crystal display device of Example 1, showing the region surrounded by the dashed-dotted circle in FIG. 18A.

FIG. 19 is a flowchart showing the production process of a second substrate in the liquid crystal display device of Example 1.

FIG. 20 is a schematic cross-sectional view of a second substrate in a liquid crystal display device of Example 2.

FIG. 21 is a flowchart showing the production process of the second substrate in the liquid crystal display device of Example 2.

FIG. 22 is a schematic cross-sectional view of a liquid crystal display device of Example 3.

FIG. 23 is a flowchart showing the production process of a second substrate in the liquid crystal display device of Example 3.

FIG. 24 is a schematic cross-sectional view of a second substrate in a liquid crystal display device of Example 4.

FIG. 25 is a flowchart showing the production process of the second substrate in the liquid crystal display device of Example 4.

FIG. 26 is a graph showing rise responses of the liquid crystal display devices of Examples 1 and 2 and a comparative example.

FIG. 27 is a schematic cross-sectional view of a liquid crystal display device of Comparative Embodiment 1.

FIG. 28 is a schematic cross-sectional view of a liquid crystal display device of Comparative Embodiment 2.

FIG. 29 is a schematic cross-sectional view of the liquid crystal display device of the comparative example.

FIG. 30 is a flowchart showing the production process of a second substrate in the liquid crystal display device of the comparative example.

### DETAILED DESCRIPTION OF THE INVENTION

The present invention is described in more detail below based on embodiments with reference to the drawings. The embodiments, however, are not intended to limit the scope of the present invention. The configurations of the embodiments may appropriately be combined or modified within the spirit of the present invention.

### Embodiment 1

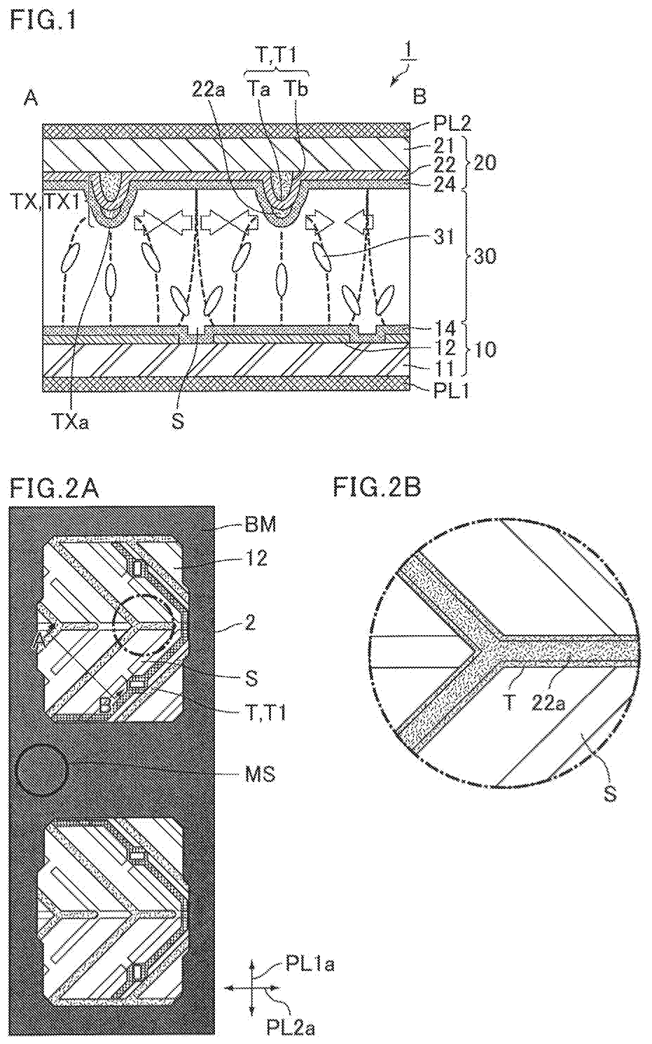

FIG. 1 is a schematic cross-sectional view of a liquid crystal display device of Embodiment 1. FIG. 2A is a schematic plan view of display units in the liquid crystal display device of Embodiment 1. FIG. 2B is an enlarged schematic plan view of a portion of a display unit in the liquid crystal display device of Embodiment 1, showing the region surrounded by a dashed-dotted circle in FIG. 2A. FIG. 1 is a schematic cross-sectional view taken along the line A-B in FIG. 2A. In the present embodiment, a MVA mode liquid crystal display device is described.

A liquid crystal display device 1 of the present embodiment includes a first substrate 10, a second substrate 20 facing the first substrate 10, a vertical alignment-type liquid crystal layer 30 held between the first substrate 10 and the second substrate 20, and display units 2 arranged in a matrix pattern in a display region. The “display unit” as used herein means a region corresponding to one pixel electrode 12, and may be a “pixel” in the art of liquid crystal display devices. In the case of divisionally driving one pixel, the display unit may be a “sub pixel” or a “dot”.

The first substrate 10 includes, in the following order toward the liquid crystal layer 30, an insulating substrate (not shown), a transparent interlayer insulating film and a base coat layer 11, pixel electrodes 12 each provided with slits S, and a first alignment film 14. The first substrate 10 includes source lines (not shown), gate lines intersecting the source lines (not shown), and thin film transistors (TFTs) (not shown). The pixel electrodes 12 are disposed in the respective regions each surrounded by two adjacent source lines and two adjacent gate lines.

The second substrate 20 includes, in the following order toward the liquid crystal layer 30, an insulating substrate (not shown), a color filter layer 21, projections T each having a tip Ta and a side surface Tb, a common electrode 22 covering the projections T, and a second alignment film 24. On the common electrode 22 are formed insulating layers 22a at the positions superposed with the tips Ta of the projections T. The projections T, the common electrode 22, the insulating layers 22a, and the second alignment film 24 constitute projection structures TX. Each projection structure TX has a surface TXa facing the first substrate 10. The surface TXa is not in contact with the first substrate 10 at the atmospheric pressure. As described below, in the present embodiment where the projections T function as ribs, the projection structures TX are also referred to as projection structures TX1. The color filter layer 21 includes a black matrix BM formed in a substantially grid pattern and color filters (CFs) (not shown) disposed inside the cells of the black matrix BM. The black matrix BM constitutes a light shielding region. Main spacers MS are dot-shaped and formed in the light shielding region.

Each TFT is a three-terminal switch that is connected to the corresponding source line and the corresponding gate line, and includes a thin film semiconductor, a source electrode that is part of the corresponding source line, a gate electrode that is part of the corresponding gate line, and a drain electrode connected to the corresponding pixel electrode 12.

Each pixel electrode 12 is connected to the corresponding source line through the corresponding thin film semiconductor. With this structure, the electric potential of each pixel can be controlled as desired by supplying a source signal to the corresponding pixel electrode 12 through electrical potential control, i.e., turning on or off the gate line. The common electrode 22 covers all the display units 2 and supplies a common predetermined voltage to all the display units 2. This generates an electric field between the pixel electrode 12 of each display unit 2 and the common electrode 22, rotating the liquid crystal molecules (liquid crystal compounds) in the liquid crystal layer 30. Controlling the magnitude of voltage applied between each pixel electrode 12 and the common electrode 22 as described above changes the retardation of the liquid crystal layer 30, controlling transmission/blocking of light.

The vertical alignment-type liquid crystal layer 30 aligns, with no voltage applied, the liquid crystal molecules 31 having negative anisotropy of dielectric constant in a direction substantially perpendicular to surfaces of each pixel electrode 12 and the common electrode 22 (e.g., at 87° or greater and 90° or smaller). Typically, the alignment is achieved using vertical alignment films (first alignment film 14 and second alignment film 24) disposed on the liquid crystal layer 30 side surfaces of the pixel electrodes 12 and common electrode 22, respectively. Herein, the state where no voltage is applied between each pixel electrode 12 and the common electrode 22 is simply referred to as a state “with no voltage applied”, while the state where voltage is applied between the pixel electrode 12 and the common electrode 22 is simply referred to as a state “with voltage applied”.

On the side remote from the liquid crystal layer 30 of the first substrate 10 and the side remote from the liquid crystal layer 30 of the second substrate 20 are disposed a first polarizing plate PL1 and a second polarizing plate PL2, respectively. The first polarizing plate PL1 and the second polarizing plate PL2 are in crossed Nicols where the polarization axes thereof are perpendicular to each other.

The projections T extend in a belt shape (linearly) in a direction intersecting (preferably in a direction forming an angle of 45° with) a polarization axis PL1a of the first polarizing plate PL1 and a polarization axis PL2a of the second polarizing plate PL2, in each display unit 2. The projections T are projections T1, which function as ribs that control the alignment of the liquid crystal molecules 31. The ribs are an alignment factor that determines the alignment of liquid crystal molecules. The liquid crystal molecules 31 with no voltage applied are aligned in a direction substantially perpendicular to the liquid crystal layer 30 side surfaces of the projections T1 functioning as ribs. The slits S extend in a belt shape (linearly) in a direction intersecting (preferably in a direction forming an angle of 45° with) the polarization axis of the first polarizing plate PL1 and the polarization axis of the second polarizing plate PL2, in each display unit 2. The projections T are parallel to the slits S in each display unit 2.

As described above, the common electrode 22 covers the projections T and the pixel electrodes 12 are each provided with the slits S (openings, portions with no conductive layer). When voltage is applied between a pixel electrode 12 and the common electrode 22, the liquid crystal molecules 31 under the alignment controlling force from the projections T and the slits S tilt (are inclined) in the directions indicated by the arrows in FIG. 1. The liquid crystal, molecules 31 tilt in one direction in a region between one projection T and one slit S (the region is also referred to as a liquid crystal region), so that the region between one projection T and one slit S can be also considered as a domain. The domain as used herein means a region defined by boundaries where the liquid crystal molecules 31 do not rotate from the initial alignment direction of the liquid crystal molecules with voltage applied. The initial alignment direction of the liquid crystal molecules is the alignment direction of the liquid crystal molecules with no voltage applied. With voltage applied, the boundaries between domains where the liquid crystal molecules 31 do not rotate from the initial alignment direction of the liquid crystal molecules are also referred to as disclination regions. In a normally black mode liquid crystal display device, disclination regions positioned in the openings are observed as dark regions transmitting no light and appear as dark lines, for example.

As shown in FIG. 1, the second substrate 20 includes the common electrode 22 covering the projections T each having the tip Ta and the side surface Tb, and no insulating layer is disposed on the common electrode 22 at the positions superposed with the side surfaces Tb of the projections T. This structure enables effective generation of oblique electric fields E near the side surfaces Tb of the projections T to tilt the liquid crystal molecules 31 near the side surfaces Tb of the projections T immediately after application of voltage (e.g., voltage giving a grayscale value of 240 or higher, with the voltage giving a grayscale value of 255 being defined as the white voltage), reducing alignment disorder. This can increase the rise response speed of the liquid crystal molecules 31.

As shown in FIG. 1, the insulating layers 22a are disposed on the common electrode 22 at the positions superposed with the tips Ta of the projections T. This structure can reduce the chances of contact between the common electrode 22 on the second substrate 20 and the pixel electrodes 12 on the first substrate 10 to reduce vertical leakage even when pressure is applied to the first substrate 10 and/or the second substrate 20 and the distance between the first substrate 10 and the second substrate 20 is reduced, for example.

Also, as shown in FIG. 1, the insulating layers 22a are disposed on the common electrode 22 at the positions superposed with the tips Ta of the projections T. The projection structures TX including the respective projections T are not in contact with the first substrate 10 at the atmospheric pressure. Applying voltage between each pixel electrode 12 and the common electrode 22 tilts (aligns) the liquid crystal molecules 31 in different directions, with the tip Ta of each projection T as a boundary. Since the tips Ta of the projections T correspond to the centers in tilting of the liquid crystal molecules 31 in different directions, it is difficult to control the alignment direction of the liquid crystal molecules 31 at the tips Ta. This unfortunately produces disclination regions. The present embodiment, in contrast, employs the insulating layers 22a at the positions superposed with the tips Ta of the projections T to weaken the electric field intensity at the tips Ta of the projections T with voltage applied. This structure can make the liquid crystal molecules 31 less likely to tilt, reducing the size of disclination regions (dark lines in the present embodiment) at the tips Ta of the projections T.

The following further describes the reason why the size of the disclination regions at the tips Ta of the projections T can be reduced by weakening the electric field intensity at the tips Ta of the projections T with voltage applied and thereby making the liquid crystal molecules 31 less likely to tilt. In a liquid crystal display device including a common electrode under the projections as in the liquid crystal display device 1R of Comparative Embodiment 1, the electric field intensity is weak, meaning that the force tilting the liquid crystal molecules toward the tips of the projections (e.g., toward the center lines of the ribs) is weak. In contrast, in a liquid crystal display device in which the surfaces of the projections are covered with the common electrode, the force tilting the liquid crystal molecules toward the tips of the projections (in the present embodiment, toward the center lines of the ribs) is stronger. Yet, around the tips of the projections, the liquid crystal molecules tilt from the side surfaces of the projections toward the tips of the projections (toward the center lines of the ribs from the horizontal direction in the case of the present invention in which the projections are ribs, and toward the tips of the spacers or rivets from all the azimuths in the cases of below-described embodiments in which the projections are spacers or rivets). The liquid crystal molecules at the tips of the projections (center portions) are therefore influenced by liquid crystal molecules under a stronger force of tilting toward the tips of the projections, and are aligned unevenly in this tilting direction. In other words, the center of the alignment of the liquid crystal molecules may vary and a stable disclination region (where the liquid crystal molecules are in the rise state) may not be maintained, so that the width of disclination region may be wide. Also, the viewing angle may be unbalanced (the compensation area ratio of the alignment of the liquid crystal molecules may change) to influence the visibility. In order to avoid such unsatisfactory results, the present embodiment and the following embodiments employ insulating layers or openings (slits) at the positions superposed with the tips of the projections on the common electrode covering the projections to mark the center of the alignment of the liquid crystal molecules. This can maintain stable disclination regions and reduce the size of the disclination regions.

In the present embodiment, the projections T are formed on the second substrate 20, and the common electrode 22, not the pixel electrodes 12, covers the projections T. Now, Comparative Embodiment 2 is studied in which the projections are formed on the first substrate and the pixel electrodes cover the projections. FIG. 28 is a schematic cross-sectional view of a liquid crystal display device of Comparative Embodiment 2. As shown in FIG. 28, a liquid crystal display device 1R of Comparative Embodiment 2 includes the first substrate 10R, the second substrate 20R facing the first substrate 10R, and the vertical alignment-type liquid crystal layer 30R held between the first substrate 10R and the second substrate 20R. The first substrate 10R includes the projections TR each having a tip TaR and a side surface TbR, the pixel electrodes 12R each provided with the slits SR in the given order toward the liquid crystal layer 30R. The second substrate 20R includes the common electrode 22R. Vertical alignment films (not shown) are disposed on the respective liquid crystal layer 30R sides of the pixel electrodes 12R and the common electrode 22R.

When voltage is applied to the liquid crystal display device 1R of Comparative Embodiment 2, as shown in FIG. 28, the direction in which the liquid crystal molecules 31R tilt under the influence of an electric field generated from a pixel electrode part 121R covering the side surface TbR of the corresponding projection TR is opposite to the direction in which the liquid crystal molecules 31R tilt under the influence of an electric field generated from a pixel electrode part 122R near the edge of a slit SR. This causes collision of the liquid crystal molecules 31R between the projection TR and the slit SR, destabilizing the alignment of the liquid crystal molecules 31R. Also, a darks line appears in a region AR where the alignment directions of the liquid crystal molecules 31R collide with each other between the projection TR and the slit SR. In collision of the liquid crystal molecules 31R, the position of the dark line depends on which force of tilting is stronger, and this produces an uneven dark line. In the liquid crystal display device 1R of Comparative Embodiment 2 where the projections TR are covered with the pixel electrodes 12R, the above defect is found between the projections TR and the slits SR. In the present embodiment where the projections T are covered with the common electrode 22, in contrast, such a defect does not occur between the projections T and the slits S. Hereinafter, the present embodiment is described in more detail.

As shown in FIG. 2A and FIG. 2B, the projections T and the slits S are each formed in a belt shape (linearly) in each display unit 2. Adjacent projections T are parallel to each other, and the distance between them is constant. Adjacent slits S are parallel to each other, and the distance between them is constant. FIG. 1 is a cross-sectional view taken in the direction perpendicular to the extension direction of the belt-shaped projections T and slits S.

Between a belt-shaped projection T and a belt-shaped slit S parallel to each other is defined a belt-shaped liquid crystal region. In each liquid crystal region, the alignment direction is controlled by the projection T and the slit S at the respective ends. On the sides of each projection T and each slit S are formed domains in which the liquid crystal molecules 31 tilt in different directions. In the liquid crystal display device 1 of the present embodiment, as shown in FIG. 2A and FIG. 2B, the projections T and the slits S each include a part branched in two directions different from each other by 90°, and thus each display unit 2 includes four liquid crystal regions in which the alignment directions of the liquid crystal molecules 31 are different from each other by 90°.

As shown in FIG. 1, the extension direction of each of the projections T and the slits S halves an angle formed by the polarization axes PL1a and PL2a of the pair of polarizing plates (first polarizing plate PL1 and second polarizing plate PL2) disposed in crossed Nicols. Although 1.5 the projections T and the slits S may be disposed in any other pattern, this pattern enables achievement of favorable viewing angle characteristics.

Each projection T includes, as shown in FIG. 2A and FIG. 2B, a part extending parallel to a slit S and a part extending parallel to an edge of the corresponding pixel electrode 12 (a part extending parallel to the polarization axis PL2a of the second polarizing plate PL2). This part of the projection T extending parallel to an edge of the corresponding pixel electrode 12 prevents the alignment of the liquid crystal molecules 31 from being disturbed by oblique electric fields from the edge of the pixel electrode 12, and can be omitted. In the present embodiment, the effects of reducing vertical leakage and increasing the rise response speed with a focus on the projections T extending in a direction intersecting the polarization axis PL1a of the first polarizing plate PL1 and the polarization axis PL2a of the second polarizing plate PL2. Yet, the same effects can be achieved by the projections T extending parallel to the polarization axis of either polarizing plate.

Each projection T has the tip Ta and the side surface Tb. The projection T has a shape tapering toward the tip Ta. The projection T has a cross-sectional shape (cross-sectional shape of a plane perpendicular to a surface of the insulating substrate of the second substrate 20) such as a semicircular or trapezoidal shape. In a cross-sectional view, the side surface Tb of the projection T is inclined from a surface of the insulating substrate of the second substrate 20, and preferably forms an angle of 10° to 55°, more preferably 20° to 45°, with the surface of the insulating substrate. In the case where there is a plurality of the projections T, the projections T may have the same shape as each other or one or more of the projections T may have a different shape from the others.

Each projection T functioning as a rib preferably has a height (thickness) of 1 μm to 2 μm, more preferably 1.2 μm to 1.6 μm, still more preferably 1.3 μm to 1.5 μm. In the case where there is a plurality of the projections T, the projections T may have the same height as each other or one or more of the projections T may have a different height from the others.

In a plan view, the projection T functioning as a rib preferably has a width of 5 μm to 35 μm, more preferably 8 μm to 25 μm. In the case where there is a plurality of the projections T, the projections T in a plan view may have the same width as each other or one or more of the projections T may have a different width from the others. The width of a projection in a plan view may also be referred to simply as “the width of a projection”.

The common electrode 22 covers the side surface Tb of each projection T. This structure can effectively generate an oblique electric field near the side surface Tb and tilt the liquid crystal molecules 31 around the projection T immediately after application of voltage (e.g., voltage giving a grayscale value of 240, with a voltage giving a grayscale value of 255 being defined as the white voltage), reducing the alignment disorder. Thereby, the rise response of the liquid crystal display device 1 is increased.

The common electrode 22 preferably has a thickness of 50 nm to 240 nm, more preferably approximately 140 nm. In order to prevent color unevenness of reflected light due to multiple interference on the front and back surfaces of the color filter layer 21 and the front and back surfaces of the common electrode 22, the thickness of the common electrode 22 can be determined in consideration of the structure of the layer(s) to be disposed under the common electrode 22.

On the common electrode 22 are formed the insulating layers 22a at the positions superposed with the tips Ta of the projections T. The insulating layers 22a are not formed at the positions superposed with the side surfaces Tb of the projections T. The insulating layers 22a at the positions superposed with the tips Ta of the projections T can reduce vertical leakage. Also, the tips Ta of the projections T cannot control the direction in which the liquid crystal molecules 31 tilt. Thus, the liquid crystal molecules 31 are in the rise (no rotating) state with voltage applied, whereby dark lines appear. The widths of such darks lines can be reduced by capping the tips Ta of the projections T with the insulating layers 22a.

Each insulating layer 22a has the same planar shape as the projections T functioning as ribs. The insulating layer 22a is formed inside a region where a projection T is formed in a plan view.

The insulating layer 22a preferably has a thickness of 0.1 μm to 1.5 μm, more preferably 0.2 μm to 1.2 μm, still more preferably 0.25 μm to 1.0 μm. A smaller thickness of the insulating layer 22a allows the common electrode 22 to be closer to the liquid crystal layer 30, more effectively generating electric fields, which move the liquid crystal molecules. Hence, the thickness of the insulating layer 22a preferably falls within the above range. In the case where there is a plurality of the insulating layers 22a, the insulating layers 22a may have the same thickness as each other or one or more of the insulating layers 22a may have a different thickness from the others. The thickness of the insulating layer 22a is the thickness of the part of the insulating layer 22a superposed with the apex (the highest point of the tip Ta) of a projection T.

The height of each projection T functioning as a rib and the thickness of the corresponding insulating layer 22a at the position superposed with the tip Ta of the projection T (height of projection T):(thickness of insulating layer 22a) preferably satisfy a ratio of 1:0.1 to 1:0.6, more preferably a ratio of 1:0.2 to 1:0.4. For more effective prevention of vertical leakage, the thickness of the insulating layer 22a is preferably 10% or more, more preferably 20% or more, of the height of the projection T. Also, for control of the thickness of the insulating layer 22a, the thickness of the insulating layer 22a is preferably 60% or less, more preferably 40% or less, still more preferably 30% to 40%, of the height of the projection T.

In a plan view, the insulating layer 22a preferably has a width of 4 μm to 20 μm, more preferably 8 μm to 16 μm. Too large a width of the insulating layer 22a decreases the aperture ratio. Hence, the width of the insulating layer 22a preferably falls within the above range. In the case where there is a plurality of the insulating layers 22a, the insulating layers 22a in a plan view may have the same width as each other or one or more of the insulating layers 22a may have a different width from the others. The width of the insulating layer in a plan view is also simply referred to as “the width of the insulating layer”.

In a plan view, the width of the projection T and the width of the insulating layer 22a at the position superposed with the tip Ta of the projection T (width of projection T):(width of insulating layer 22a) preferably satisfy a ratio of 1:0.1 to 1:0.9, more preferably a ratio of 1:0.2 to 1:0.4. A smaller width of the insulating layer 22a relative to the width of the projection T can more effectively generate electric fields, which move the liquid crystal molecules. Yet, too small a width of the insulating layer 22a relative to the width of the projection T may lead to ineffective reduction of vertical leakage. Thus, the ratio (width of projection T):(width of insulating layer 22a) preferably falls within the above range.

The edge of the insulating layer 22a is preferably at a distance ⅛ or more and ⅓ or less, more preferably ⅙ or more and ¼ or less, of the height of the projection from the tip of the projection. The insulating layer 22a formed at a distance ⅛ or more of the height of the projection from the tip of the projection can effectively reduce the chances of contact between the common electrode 22 on the second substrate 20 and the pixel electrodes 12 on the first substrate 10, further reducing vertical leakage. Also, the insulating layer 22a formed at a distance ⅓ or less of the height of the projection from the tip of the projection can more effectively generate an oblique electric field near the side surface Tb of the projection T, further increasing the rise response speed of the liquid crystal molecules 31. Here, the tip of the projection is the portion closest to the first substrate.

Examples of the insulating substrate in the first substrate 10 and the second substrate 20 include substrates such as glass substrates and plastic substrates.

Each pixel electrode 12 of the first substrate 10 preferably has a thickness of 30 nm to 140 nm, more preferably 40 nm to 100 nm.

The color filter layer 21 of the second substrate 20 includes the black matrix BM formed in a substantially grid pattern and the CFs formed inside the cells of the black matrix BM. Each display unit 2 includes a red, green, or blue CF, and three display units 2 of red, green, and blue are formed in a stripe pattern. The black matrix BM included in the color filter layer 21 can be formed from a photoresist containing a photosensitive resin and carbon black, and has a thickness of 2.0 μm to 3.0 μm and a width of 10 μm to 20 μm, for example. Each CF included in the color filter layer 21 has a thickness of 1.6 μm to 2.0 μm, for example.

The liquid crystal layer 30 contains a liquid crystal material. Applying voltage to the liquid crystal layer 30 to change the alignment of the liquid crystal molecules 31 of the liquid crystal material in response to the applied voltage enables control of the amount of light transmitted.

The anisotropy of dielectric constant (Δε) defined by the following formula of the liquid crystal material used in the present embodiment is negative. The liquid crystal material having negative anisotropy of dielectric constant is also referred to as a negative liquid crystal material. The major axis direction of each liquid crystal molecule is the slow axis direction. The liquid crystal molecules are homeotropically aligned with no voltage applied. The major axis direction of each liquid crystal molecule with no voltage applied is also referred to as the initial alignment direction of the liquid crystal molecule.

Δε=(dielectric constant in major axis direction)−(dielectric constant in minor axis direction)

Each vertical alignment film has a function to control the alignment of liquid crystal molecules 31 in the liquid crystal layer 30. With no voltage applied, the alignment of the liquid crystal molecules 31 in the liquid crystal layer 30 is mainly controlled by the functions of the vertical alignment films. In this state, the angle of the major axis of each liquid crystal molecule 31 from the surface of a substrate (first substrate 10 or second substrate 20) is called the pre-tilt angle. The “pre-tilt angle” as used herein means the angle of inclination of the liquid crystal molecule 31 from the direction parallel to the substrate surface, with the angle of a line parallel to the substrate surface being defined as 0° and the angle of the line normal to the substrate surface being defined as 90°. The vertical alignment films each can align the liquid crystal molecules 31 in the liquid crystal layer 30 in a substantially perpendicular direction (i.e., is a vertical alignment film), giving a pre-tilt angle of 87° or greater and 90° or smaller.

The method for producing the liquid crystal display device 1 of the present embodiment is described.

The second substrate 20 can be produced as follows. First, the black matrix BM is formed on an insulating substrate in a substantially grid pattern from a conventional black photosensitive resin material. A red photoresist containing a coloring material such as a pigment as a red-colored photosensitive resin is applied to the inside of the target cells of the black matrix BM, followed by light exposure and development, so that red resin layers (red color layers) are formed in every three display units 2. Green resin layers (green color layers) and blue resin layers (blue color layers) are then formed by the same procedure, whereby the color filter layer 21 is formed on the insulating substrate.

To the color filter layer 21 is applied a photosensitive resin composition (negative resist or positive resist). The composition is patterned by a technique such as photolithography, so that the projections T can be formed. In terms of the reliability, the projections T are preferably formed from a negative resist.

The common electrode 22 can be obtained by forming a film of a transparent conductive material such as indium tin oxide (ITO) or indium zinc oxide (IZO) by a technique such as sputtering to cover the projections T.

The insulating layers 22a can be formed at the positions superposed with the tips Ta of the projections T by, for example, applying a photosensitive resin composition (negative resist or positive resist) to the common electrode 22 and patterning the composition by a technique such as photolithography.

A vertical alignment film can be formed by applying a vertical alignment film material to the common electrode 22 on which the insulating layers 22a are formed. The vertical alignment film material can be, for example, a polymer for alignment films usually used in the field of liquid crystal display devices, such as a polyimide. The vertical alignment film material can be applied by printing. The printing can be, for example, inkjet printing. Thereby, the second substrate 20 can be produced.

The first substrate 10 can be produced as follows. A film of a transparent conductive material such as indium tin oxide (ITO) or indium zinc oxide (IZO) is formed on an insulating substrate by a technique such as sputtering. The film is etched by a technique such as photolithography, whereby the pixel electrodes 12 each provided with the slits S can be formed. A vertical alignment film material is applied to the pixel electrodes 12, so that a vertical alignment film can be formed. The vertical alignment film material can be, for example, a polymer for alignment films usually used in the field of liquid crystal display devices, such as a polyimide. The vertical alignment film material can be applied by printing. The printing can be, for example, inkjet printing. Thereby, the first substrate 10 can be produced.

A sealant is applied to either the first substrate 10 or the second substrate 20 produced as above to form the liquid crystal layer 30 in the region surrounded by the sealant. The first substrate 10 and the second substrate 20 are bonded to each other with the sealant, followed by curing of the sealant. Thereby, the liquid crystal display device 1 of the present embodiment including the liquid crystal layer 30 in the region surrounded by the first substrate 10, the second substrate 20, and the sealant can be produced. The liquid crystal layer 30 can be formed in the region surrounded by the sealant also after bonding of the first substrate 10 and the second substrate 20 to each other. Specifically, vacuum injection can be employed which forms an inlet for the sealant application pattern and injects the liquid crystal in a vacuum chamber.

### Embodiment 2

In the present embodiment, the features unique to the present embodiment are mainly described, and description of the same features as in the above embodiment is not repeated here. On the common electrode 22 in Embodiment 1 are formed the insulating layers 22a at the positions superposed with the tips Ta of projections T1 functioning as ribs, but not at the positions superposed with the side surfaces Tb of the projections T1 functioning as ribs. The common electrode in the present embodiment is provided with openings at the positions superposed with the tips of the projections functioning as ribs.

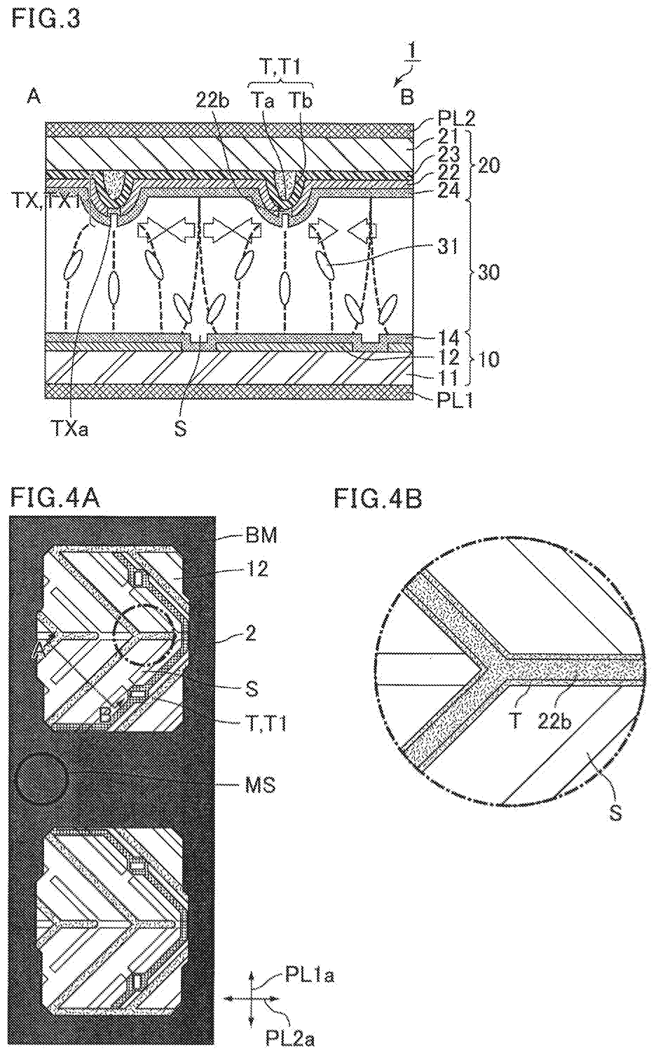

FIG. 3 is a schematic cross-sectional view of a liquid crystal display device of Embodiment 2. FIG. 4A is a schematic plan view of display units in the liquid crystal display device of Embodiment 2. FIG. 4B is an enlarged schematic plan view of a portion of a display unit in the liquid crystal display device of Embodiment 2, showing the region surrounded by the dashed-dotted circle in FIG. 4A. FIG. 3 is a schematic cross-sectional view taken along the line A-B in FIG. 4A. A MVA mode liquid crystal display device is described in the present embodiment.

The liquid crystal display device 1 of the present embodiment includes the first substrate 10, the second substrate 20 facing the first substrate 10, the vertical alignment-type liquid crystal layer 30 held between the first substrate 10 and the second substrate 20, and the display units 2 arranged in a matrix pattern in the display region.

The first substrate 10 includes, in the following order toward the liquid crystal layer 30, an insulating substrate (not shown), a transparent interlayer insulating film and the base coat layer 11, the pixel electrodes 12 each provided with the slits S, and the first alignment film 14. The second substrate 20 includes, in the following order toward the liquid crystal layer 30, an insulating substrate (not shown), the color filter layer 21, the projections T each having the tip Ta and the side surface Tb, a passivation film 23 covering the projections T, the common electrode 22 covering the passivation film 23, and the second alignment film 24. The common electrode 22 is provided with openings 22b at the positions superposed with the tips Ta of the projections T. The projections T, the passivation film 23, the common electrode 22, and the second alignment film 24 constitute the projection structures TX (TX1). Each projection structure TX has the surface TXa facing the first substrate 10. The surface TXa is not in contact with the first substrate 10 at the atmospheric pressure. The color filter layer 21 includes the black matrix BM formed in a substantially grid pattern and the CFs (not shown) disposed inside the cells of the black matrix BM. The black matrix BM constitutes a light shielding region. The main spacers MS are dot-shaped and formed in the light shielding region.

As shown in FIG. 3, the second substrate 20 includes the common electrode 22 covering the projections T, and the common electrode 22 is not provided with openings at the positions superposed with the side surfaces Tb of the projections T. Between the projections T and the common electrode 22 is provided the passivation film 23 covering the projections T. Even in the case where the passivation film 23 is provided between the projections T and the common electrode 22, the passivation film 23 and the common electrode 22 conform to the shape of the projections T. This structure enables effective generation of the oblique electric fields E near the side surfaces Tb of the projections T to tilt the liquid crystal molecules 31 near the side surfaces Tb of the projections T immediately after application of voltage (e.g., the white voltage), reducing the alignment disorder. This can increase the rise response speed of the liquid crystal molecules 31. Also in the present embodiment, the passivation film 23 is provided between the projections T and the common electrode 22, and the common electrode 22 is disposed at a position under the second alignment film 24 (on the side remote from the liquid crystal layer 30 of the second alignment film 24) and closer to the liquid crystal layer 30 than the passivation film 23 is. This structure can reduce weakening of the electric field intensity.

The common electrode 22 is provided with the openings 22b at the positions superposed with the tips Ta of the projections T. This structure can reduce the chances of contact between the common electrode 22 on the second substrate 20 and the pixel electrodes 12 on the first substrate 10 to reduce vertical leakage even when pressure is applied to the first substrate 10 and/or the second substrate 20 and the distance between the first substrate 10 and the second substrate 20 is reduced, for example.

The common electrode 22 is provided with the openings 22b at the positions superposed with the tips Ta of the projections T. The projection structures TX including the respective projections T are not in contact with the first substrate 10 at the atmospheric pressure. This structure can weaken the electric field intensity at the tips Ta of the projections T with voltage applied and make the liquid crystal molecules 31 less likely to tilt, reducing the size of disclination regions (dark lines in the present embodiment) at the tips Ta of the projections T.

Each opening 22b has the same planar shape as the projections T functioning as ribs. The opening 22b is formed inside a region where a projection T is formed in a plan view.

The openings 22b can be formed by, for example, disposing the passivation film 23 to cover the projections T, forming the common electrode 22 on the passivation film 23, applying a resist to the common electrode 22, and etching the regions superposed with the tips Ta of the projections T using oxalic acid, for example. The passivation film 23 can prevent the projections T from being etched in the etching of the common electrode 22.

The passivation film 23 can be, for example, an inorganic film such as a silicon nitride (SiNx) film or a silicon oxide (SiO2) film, or a stack of such films. The passivation film 23 preferably has a thickness of 20 nm to 400 nm, more preferably 50 nm to 200 nm.

In a plan view, each opening 22b preferably has a width of 2 μm to 20 μm, more preferably 2 μm to 12 μm. Too large a width of the opening 22b decreases the aperture ratio of the liquid crystal display device 1. Hence, the width of the opening 22b preferably falls within the above range. In the case where there is a plurality of the openings 22b, the openings 22b in a plan view may have the same width as each other or one or more of the openings 22b may have a different width from the others. The width of the opening in a plan view is also simply referred to as “the width of the opening”.

In a plan view, the width of each projection T and the width of the corresponding opening 22b at the position superposed with the tip Ta of the projection T (width of projection T):(width of opening 22b) preferably satisfy a ratio of 1:0.1 to 1:0.6, more preferably a ratio of 1:0.1 to 1:0.4. A smaller width of the opening 22b relative to the width of the projection T can more effectively generate electric fields, which move the liquid crystal molecules. Yet, too small a width of the opening 22b relative to the width of the projection T may lead to ineffective reduction of vertical leakage. Thus, the ratio (width of projection T):(width of opening 22b) preferably falls within the above range.

The edge of the opening 22b is preferably at a distance ⅛ or more and ⅓ or less, more preferably ⅙ or more and ¼ or less, of the height of the projection from the tip of the projection. The opening 22b formed at a distance ⅛ or more of the height of the projection from the tip of the projection can effectively reduce the chances of contact between the common electrode 22 on the second substrate 20 and the pixel electrodes 12 on the first substrate 10, further reducing vertical leakage. Also, the opening 22b formed at a distance ⅓ or less of the height of the projection from the tip of the projection can more effectively generate an oblique electric field near the side surface Tb of the projection T, further increasing the rise response speed of the liquid crystal molecules 31.

### Embodiment 3

In the present embodiment, the features unique to the present embodiment are mainly described, and description of the same features as in the above embodiments is not repeated here. Although the case where the projections T function as ribs is described in Embodiment 1, the case where the projections function as main spacers is described in the present embodiment. The main spacers are used to maintain the constant gap in which the liquid crystal layer is formed.

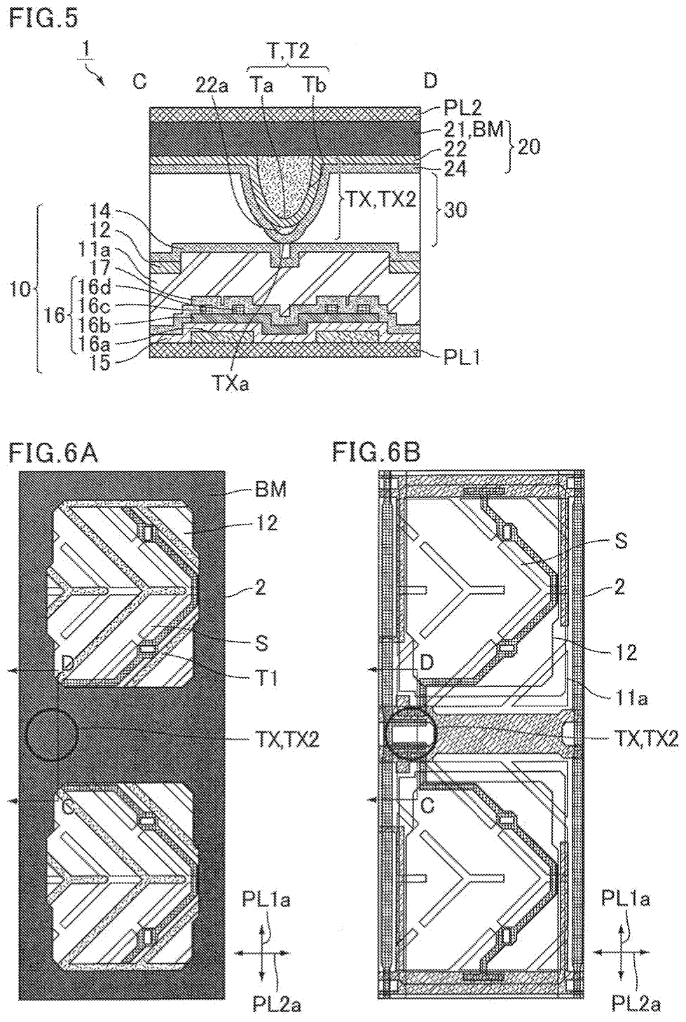

FIG. 5 is a schematic cross-sectional view of a liquid crystal display device of Embodiment 3. FIG. 6A is a schematic plan view of display units in the liquid crystal display device of Embodiment 3. FIG. 6B is a schematic plan view of the display units in the liquid crystal display device of Embodiment 3 with a focus on a first substrate. FIG. 5 is a schematic cross-sectional view taken along the line C-D in FIG. 6A. FIG. 6B also shows the line C-D to clarify the position of the line C-D in the first substrate. A MVA mode liquid crystal display device is described in the present embodiment.

The liquid crystal display device 1 of the present embodiment includes the first substrate 10, the second substrate 20 facing the first substrate 10, the vertical alignment-type liquid crystal layer 30 held between the first substrate 10 and the second substrate 20, and the display units 2 arranged in a matrix pattern in the display region.

The first substrate 10 includes, in the following order toward the liquid crystal layer 30, an insulating substrate, gate electrodes 16a, a gate insulator 15, thin film semiconductor layers 16b, drain electrodes 16c and source electrodes 16d, a passivation film 17, a transparent insulating film 11a, the pixel electrodes 12 each provided with the slits S, and the first alignment film 14. Each of the gate electrodes 16a, the corresponding thin film semiconductor layer 16b, the corresponding drain electrode 16c, and the corresponding source electrode 16d constitute a thin film transistor 16.

The second substrate 20 includes, in the following order toward the liquid crystal layer 30, an insulating substrate, the color filter layer 21, the projections T each having the tip Ta and the side surface Tb, the common electrode 22 covering the projections T, and the second alignment film 24. On the common electrode 22 are formed the insulating layers 22a at the positions superposed with the tips Ta of the projections T. The projections T, the common electrode 22, the insulating layers 22a, and the second alignment film 24 constitute the projection structures TX. Each projection structure TX has the surface TXa facing the first substrate 10. The surface TXa is not in contact with the first substrate 10 at the atmospheric pressure. The projections T in the present embodiment are projections T2 functioning as main spacers that maintain the gap in which the liquid crystal layer 30 is formed. In the present embodiment in which the projections T function as main spacers, the projection structures TX are also referred to as projection structures TX2. The color filter layer 21 includes the black matrix BM formed in a substantially grid pattern and the CFs disposed inside the cells of the black matrix BM. The black matrix BM constitutes a light shielding region. The projections T2 functioning as main spacers are dot-shaped and formed in the light shielding region.

The passivation film 17 can be, for example, an inorganic film such as a silicon nitride (SiNx) film or a silicon oxide (SiO₂) film, or a stack of such films.

The liquid crystal display device 1 of the present embodiment includes the common electrode 22 covering the projections T each having the tip Ta and the side surface Tb, and no insulating layer is formed on the common electrode 22 at the positions superposed with the side surfaces Tb of the projections T. This structure enables effective generation of the oblique electric fields E near the side surfaces Tb of the projections T immediately after application of voltage (e.g., voltage giving a grayscale value of 240 or higher, with the voltage giving a grayscale value of 255 being defined as the white voltage), tilting the liquid crystal molecules 31 near the side surfaces Tb of the projections T. The projections T in the present embodiment are main spacers and formed in the light shielding region. As the liquid crystal molecules 31 in the light shielding region tilt immediately after application of voltage, the liquid crystal molecules 31 in the display region adjacent to the light shielding region become likely to tilt immediately after the application of voltage. This can reduce the alignment disorder, and thereby increase the rise response speed of the liquid crystal molecules 31.

In the case where the projections T are main spacers, the common electrode 22 at the positions superposed with the tips Ta of the projections T may come into contact with the TFT bus lines disposed on the counter substrate (first substrate 10). Yet, since the insulating layers 22a are formed on the common electrode 22 at the positions superposed with the tips Ta of the projections T, the contact can be avoided, and thereby vertical leakage can be reduced.

Each projection T has the tip Ta and the side surface Tb. The projection T has a shape tapering toward the tip Ta. The projection T has a cross-sectional shape such as a semicircular or trapezoidal shape in a plane perpendicular to a surface of the insulating substrate of the second substrate 20. In a cross-sectional view, the side surface Tb of the projection T is inclined from a surface of the insulating substrate of the second substrate 20, and preferably forms an angle of 40° to 90°, more preferably 50° to 80°, with the surface of the insulating substrate. The projections T may have the same shape as each other or one or more of the projections T may have a different shape from the others.

Each projection T functioning as a main spacer preferably has a height (thickness) of 2.5 μm to 5.0 μm, more preferably 2.8 μm to 4.8 μm, still more preferably 3:0 μm to 4.5 μm.

The bottom surface of each projection T functioning as a main spacer has a shape such as a circle, an ellipse, or a shape resembling an ellipse, including an oval with at least one symmetrical axis. The bottom surface (surface remote from the first substrate 10) of the projection T functioning as a main spacer preferably has a shortest diameter of 10 μm to 60 μm, more preferably 20 μm to 50 μm. In the case where there is a plurality of the projections T, the bottom surfaces of the projections T may have the same shortest diameter as each other or one or more of the bottom surfaces of the projections T may have a different shortest diameter from the others. In the case where the bottom surface has a circular shape, the shortest diameter means the diameter.

Each insulating layer 22a has the same planar shape as the projections T functioning as main spacers. The insulating layer 22a in a plan view is formed inside a region where a projection T is formed.

The insulating layer 22a preferably has a thickness of 0.1 μm to 1.5 μm, more preferably 0.2 μm to 1.2 μm, still more preferably 0.25 μm to 1.0 μm.

The height of each projection T functioning as a main spacer and the thickness of the corresponding insulating layer 22a at the position superposed with the tip Ta of the projection T (height of projection T):(thickness of insulating layer 22a) preferably satisfy a ratio of 1:0.05 to 1:0.2, more preferably a ratio of 1:0.06 to 1:0.1. For more effective prevention of vertical leakage, the thickness of the insulating layer 22a is preferably 5% or more, more preferably 6% or more, of the height of the projection T. Also, for more effective generation of an electric field, which moves the liquid crystal molecules, the thickness of the insulating layer 22a is preferably small, and is preferably 20% or less, more preferably 10% or less, of the height of the projection T.

The bottom surface of the insulating layer 22a preferably has a shortest diameter of 5 μm to 20 μm, more preferably 8 μm to 16 μm. Too large a shortest diameter of the insulating layer 22a decreases the aperture ratio. Hence, the shortest diameter of the bottom surface of the insulating layer 22a preferably falls within the above range. In the case where there is a plurality of the insulating layers 22a, the bottom surfaces of the insulating layers 22a may have the same shortest diameter as each other or one or more of the bottom surfaces of the insulating layers 22 may have a different shortest diameter from the others.

The shortest diameter of the bottom surface of the projection T and the shortest diameter of the bottom surface of the insulating layer 22a at the position superposed with the tip Ta of the projection T (shortest diameter of bottom surface of projection T):(shortest diameter of bottom surface of insulating layer 22a) preferably satisfy a ratio of 1:0.05 to 1:0.9, more preferably a ratio of 1:0.06 to 1:0.32. A smaller shortest diameter of the bottom surface of the insulating layer 22a relative to the shortest diameter of the bottom surface of the projection T can more effectively generate electric fields, which move the liquid crystal molecules. Yet, too small a shortest diameter of the bottom surface of the insulating layer 22a relative to the shortest diameter of the bottom surface of the projection T may lead to ineffective reduction of vertical leakage. Thus, the ratio (shortest diameter of bottom surface of projection T):(shortest diameter of bottom surface of insulating layer 22a) preferably falls within the above range.

Although the ribs on the substrate and the slits in the electrodes enable production of a MVA mode liquid crystal display device, controlling the alignment of the liquid crystal, molecules by photoalignment treatment without the ribs and slits also enables production of a MVA mode liquid crystal display device. The MVA mode liquid crystal display device produced by photoalignment treatment is particularly referred to as a ultra-violet induced multi domain (UV²A) mode liquid crystal display device. The liquid crystal display device 1 of the present embodiment including the projections T2 functioning as main spacers is applicable not only to a MVA mode liquid crystal display device 1 including ribs on the substrate but also to a liquid crystal display device in a display mode without ribs, such as the UV2A mode.

### Embodiment 4

In the present embodiment, the features unique to the present embodiment are mainly described, and description of the same features as in the above embodiments is not repeated here. On the common electrode 22 in Embodiment 3 are formed the insulating layers 22a at the positions superposed with the tips Ta of projections T2 functioning as main spacers, but not at the positions superposed with the side surfaces Tb of the projections T2 functioning as main spacers. The common electrode in the present embodiment is provided with openings at the positions superposed with the tips of the projections functioning as main spacers, and is not provided with openings at the positions superposed with the side surfaces of the projections functioning as main spacers.

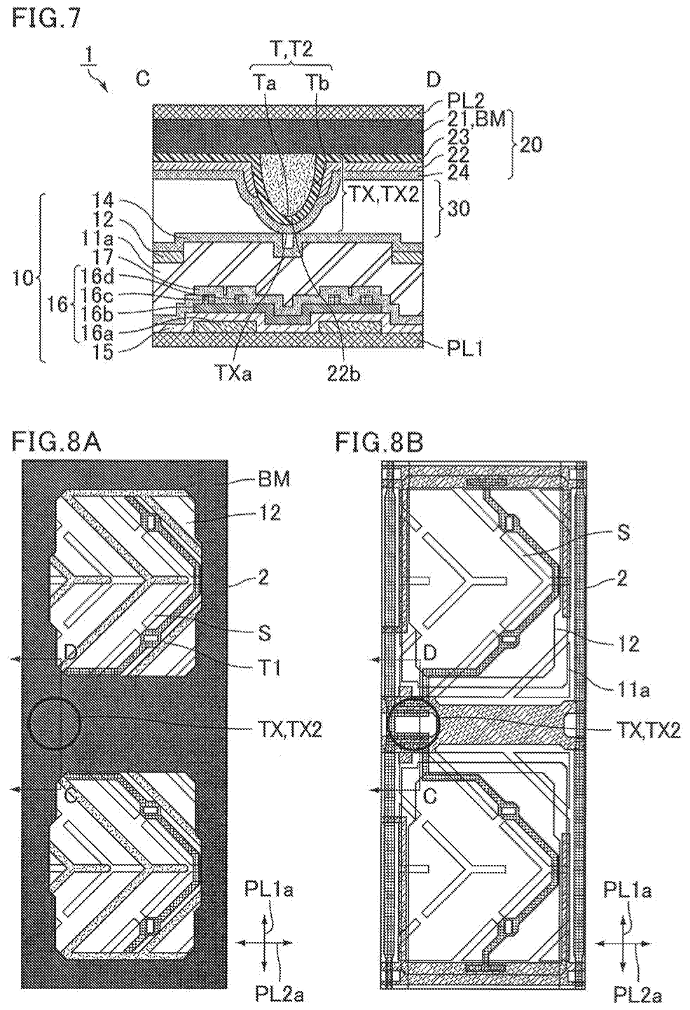

FIG. 7 is a schematic cross-sectional view of a liquid crystal display device of Embodiment 4. FIG. 8A is a schematic plan view of display units in the liquid crystal display device of Embodiment 4. FIG. 8B is a schematic plan view of the display units in the liquid crystal display device of Embodiment 4 with a focus on a first substrate. FIG. 7 is a schematic cross-sectional view taken along the line C-D in FIG. 8A. FIG. 8B also shows the line C-D to clarify the position of the line C-D in the first substrate. A MVA mode liquid crystal display device is described in the present embodiment.

The liquid crystal display device 1 of the present embodiment includes the first substrate 10, the second substrate 20 facing the first substrate 10, the vertical alignment-type liquid crystal layer 30 held between the first substrate 10 and the second substrate 20, and the display units 2 arranged in a matrix pattern in the display region.

The first substrate 10 includes, in the following order toward the liquid crystal layer 30, an insulating substrate, the gate electrodes 16a, the gate insulator 15, the thin film semiconductor layers 16b, the drain electrodes 16c and the source electrodes 16d, the passivation film 17, the transparent insulating film 11a, the pixel electrodes 12 each provided with the slits S, and the first alignment film 14. Each of the gate electrodes 16a, the corresponding thin film semiconductor layer 16b, the corresponding drain electrode 16c, and the corresponding source electrode 16d constitute a thin film transistor 16. The second substrate 20 includes, in the following order toward the liquid crystal layer 30, an insulating substrate, the color filter layer 21, the projections T each having the tip Ta and the side surface Tb, the passivation film 23 covering the projections T, the common electrode 22 covering the passivation film 23, and the second alignment film 24. The common electrode 22 is provided with the openings 22b at the positions superposed with the tips Ta of the projections T. The projections T, the passivation film 23, the common electrode 22, and the second alignment film 24 constitute the projection structures TX (TX2). Each projection structure TX has the surface TXa facing the first substrate 10. The surface TXa is in contact with the first substrate 10 at the atmospheric pressure. The color filter layer 21 includes the black matrix BM formed in a substantially grid pattern and the CFs disposed inside the cells of the black matrix BM.

The present embodiment employs the common electrode 22 covering the projections T each having the tip Ta and the side surface Tb, and the common electrode 22 is not provided with openings at the positions superposed with the side surfaces Tb of the projections T. Between the projections T and the common electrode 22 is provided the passivation film 23 covering the projections T. Even in the case where the passivation film 23 is provided between the projections T and the common electrode 22, the passivation film 23 and the common electrode 22 conform to the shape of the projections T. This structure enables effective generation of the oblique electric fields E near the side surfaces Tb of the projections T to tilt the liquid crystal molecules 31 near the side surfaces Tb of the projections T immediately after application of voltage (e.g., voltage giving a grayscale value of 240 or higher, with the voltage giving a grayscale value of 255 being defined as the white voltage), reducing the alignment disorder. This can increase the rise response speed of the liquid crystal molecules 31.

The common electrode 22 is provided with the openings 22b at the positions superposed with the tips Ta of the projections T. This structure can reduce contact, reducing vertical leakage.

Each opening 22b has the same planar shape as the projections T functioning as main spacers. The opening 22b is formed inside a region where a projection T is formed in a plan view.

In a plan view, each opening 22b preferably has a shortest diameter of 5 μm to 20 μm, more preferably 8 μm to 16 μm. Too large a shortest diameter of the opening 22b decreases the aperture ratio of the liquid crystal display device 1. Hence, the shortest diameter of the opening 22b preferably falls within the above range. In the case where there is a plurality of the openings 22b, the openings 22b in a plan view may have the same shortest diameter as each other or one or more of the openings 22b may have a different shortest diameter from the others. The shortest diameter of the opening in a plan view is also simply referred to as “the shortest diameter of the opening”.

The shortest diameter of the bottom surface of each projection T and the shortest diameter of the corresponding opening 22b at the position superposed with the tip Ta of the projection T (shortest diameter of bottom surface of projection T):(shortest diameter of opening 22b) preferably satisfy a ratio of 1:0.05 to 1:0.4, more preferably a ratio of 1:0.06 to 1:0.32. A smaller shortest diameter of the opening 22b relative to the shortest diameter of the bottom surface of the projection T can more effectively generate electric fields, which move the liquid crystal molecules. Yet, too small a shortest diameter of the opening 22b relative to the shortest diameter of the bottom surface of the projection T may lead to ineffective reduction of vertical leakage. Thus, the ratio (shortest diameter of bottom surface of projection T):(shortest diameter of opening 22b) preferably falls within the above range.

For further reduction of vertical leakage, the area of the opening 22b in a plan view is preferably ⅓ or more of the bottom surface area of the projection T.

### Embodiment 5

In the present embodiment, the features unique to the present embodiment are mainly described, and description of the same features as in the above embodiments is not repeated here. Although the case where the projections T function as ribs is described in Embodiment 1 and the case where the projections function as spacers in Embodiment 3, the case where the projections T function as rivets is described in the present embodiment.

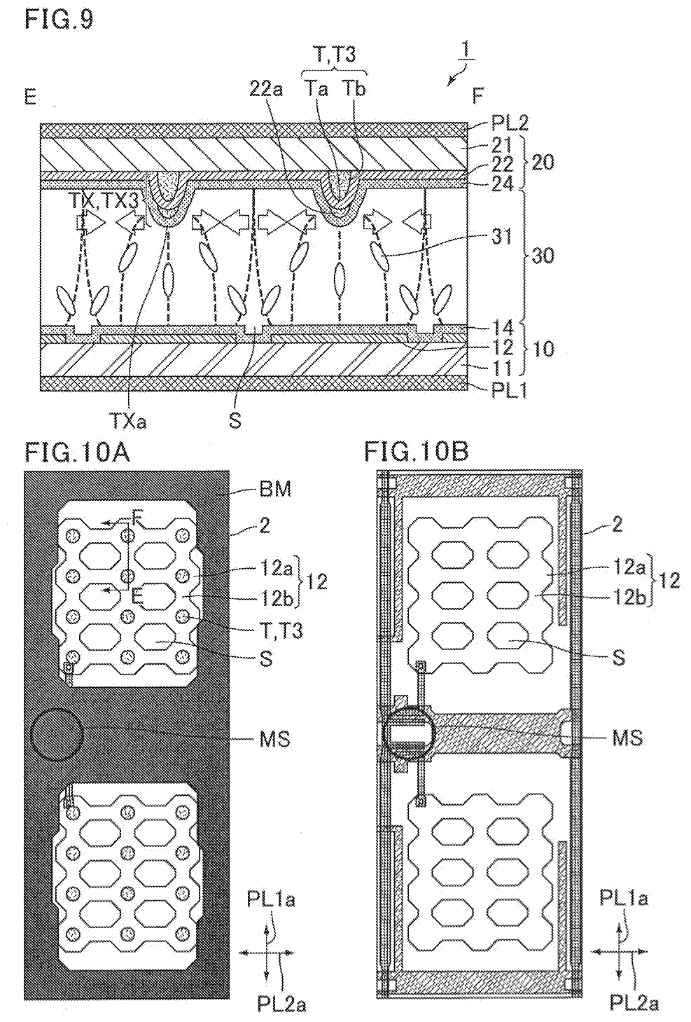

FIG. 9 is a schematic cross-sectional view of a liquid crystal display device of Embodiment 5. FIG. 10A is a schematic plan view of display units in the liquid crystal display device of Embodiment 5. FIG. 10B is a schematic plan view of the display units in the liquid crystal display device of Embodiment 5 with a focus on a first substrate. FIG. 9 is a schematic cross-sectional view taken along the line E-F in FIG. 10A. A MVA mode liquid crystal display device is described in the present embodiment.

The liquid crystal display device 1 of the present embodiment includes the first substrate 10, the second substrate 20 facing the first substrate 10, the vertical alignment-type liquid crystal layer 30 held between the first substrate 10 and the second substrate 20, and the display units 2 arranged in a matrix pattern in the display region.

The first substrate 10 includes, in the following order toward the liquid crystal layer 30, an insulating substrate, a transparent interlayer insulating film and the base coat layer 11, the pixel electrodes 12 each provided with the slits S, and the first alignment film 14. The second substrate 20 includes, in the following order toward the liquid crystal layer 30, an insulating substrate, the color filter layer 21, the projections T each having the tip Ta and the side surface Tb, the common electrode 22 covering the projections T, and the second alignment film 24. The portions surrounded by a circle in FIG. 10A and FIG. 108 indicate main spacers. On the common electrode 22 are formed the insulating layers 22a at the positions superposed with the tips Ta of the projections T. The projections T, the common electrode 22, the insulating layers 22a, and the second alignment film 24 constitute the projection structures TX. Each projection structure TX has the surface TXa facing the first substrate 10. The surface TXa is not in contact with the first substrate 10 at the atmospheric pressure. In the present embodiment in which the projections T function as rivets, the projection structures TX are also referred to as projection structures TX3. The color filter layer 21 includes the black matrix BM formed in a substantially grid pattern and the CFs disposed inside the cells of the black matrix BM. The black matrix BM constitutes a light shielding region. The main spacers MS are dot-shaped and formed in the light shielding region.

Each pixel electrode 12 includes at least one point symmetrical part 12a. The projections T are dot-shaped and formed at the positions corresponding to the centers of the point symmetrical parts 12a. The projection structures TX including the respective projections T and the respective insulating layers 22a at the positions superposed with the tips Ta of the projections T are not in contact with the first substrate 10 at the atmospheric pressure. The projections T in the present embodiment are projections T3 functioning as rivets that control the alignment of the liquid crystal molecules 31. The projections T3 functioning as rivets are formed from a dielectric. The liquid crystal molecules are aligned obliquely toward the projections T3 functioning as rivets with no voltage applied. Such oblique alignment of the liquid crystal molecules with no voltage applied obliquely aligns the liquid crystal molecules sequentially with voltage applied, starting from those near the projections T. This enables a wide viewing angle and further increases the contrast ratio of the display.

The point symmetrical part 12a of each pixel electrode 12 may have, for example, a circular shape or a regular n-sided polygonal shape (n is an integer of 3 or greater, preferably an integer of 4 or greater and 8 or smaller). In the case where the pixel electrode 12 each include a plurality of the point symmetrical parts 12a, each point symmetrical part 12a is connected to at least one other point symmetrical part 12a through a connection part 12b.

The present embodiment employs the common electrode 22 covering the projections T each having the tip Ta and the side surface Tb, and no insulating layer is formed on the common electrode 22 at the positions superposed with the side surfaces Tb of the projections T. This structure enables effective generation of the oblique electric fields E near the side surfaces Tb of the projections T to tilt the liquid crystal molecules 31 near the side surfaces Tb of the projections T immediately after application of voltage (e.g., voltage giving a grayscale value of 240 or higher, with the voltage giving a grayscale value of 255 being defined as the white voltage), reducing the alignment disorder. This can increase the rise response speed of the liquid crystal molecules 31.

On the common electrode 22 are formed the insulating layers 22a at the positions superposed with the tips Ta of the projections T. This structure can reduce the chances of contact between the common electrode 22 on the second substrate 20 and the pixel electrodes 12 on the first substrate 10 to reduce vertical leakage even when pressure is applied to the first substrate 10 and/or the second substrate 20 and the distance between the first substrate 10 and the second substrate 20 is reduced, for example.

On the common electrode 22 are formed the insulating layers 22a at the positions superposed with the tips Ta of the projections T. This structure can weaken the electric field intensity at the tips Ta of the projections T with voltage applied and make the liquid crystal molecules 31 less likely to tilt, reducing the size of disclination regions at the tips Ta of the projections T.

Each projection T functioning as a rivet preferably has a height (thickness) of 1 μm to 2 μm, more preferably 1.2 μm to 1.6 μm, still more preferably 1.3 μm to 1.5 μm.

The bottom surface of the projection T functioning as a rivet preferably has a diameter of 5 μm to 35 μm, more preferably 8 μm to 25 μm. The rivet may have a shape such as a column, a circular cone, or a circular truncated cone.

Each insulating layer 22a has the same planar shape as the projections T functioning as rivets. The insulating layer 22a is formed inside a region where a projection T is formed in a plan view.

The insulating layer 22a preferably has a thickness of 0.1 μm to 1.5 μm, more preferably 0.2 μm to 1.2 μm, still more preferably 0.25 μm to 1.0 μm.

The height of each projection T functioning as a rivet and the thickness of the corresponding insulating layer 22a at the position superposed with the tip Ta of the projection T (height of projection T):(thickness of insulating layer 22a) preferably satisfy a ratio of 1:0.1 to 1:0.6, more preferably a ratio of 1:0.2 to 1:0.4. For more effective prevention of vertical leakage, the thickness of the insulating layer 22a is preferably 10% or more, more preferably 20% or more, of the height of the projection T. Also, for control of the thickness of the insulating layer 22a, the thickness of the insulating layer 22a is preferably 60% or less, more preferably 40% or less, still more preferably 30% to 40%, of the height of the projection T.

The bottom surface of the insulating layer 22a preferably has a diameter of 4 μm to 20 μm, more preferably 8 μm to 16 μm. Too large a diameter of the bottom surface of the insulating layer 22a decreases the aperture ratio. Hence, the diameter of the bottom surface of the insulating layer 22a preferably falls within the above range. In the case where there is a plurality of the insulating layers 22a, the bottom surfaces of the insulating layers 22a may have the same diameter as each other or one or more of the bottom surfaces of the insulating layers 22a may have a different diameter from the others.

The diameter of the bottom surface of the projection T and the diameter of the bottom surface of the insulating layer 22a at the position superposed with the tip Ta of the projection T (diameter of bottom surface of projection T):(diameter of bottom surface of insulating layer 22a) preferably satisfy a ratio of 1:0.1 to 1:0.9, more preferably a ratio of 1:0.2 to 1:0.4. A smaller diameter of the bottom surface of the insulating layer 22a relative to the diameter of the bottom surface of the projection T can more effectively generate electric fields, which move the liquid crystal molecules. Yet, too small a diameter of the bottom surface of the projection T may lead to ineffective reduction of vertical leakage. Thus, the ratio (diameter of bottom surface of projection T):(diameter of bottom surface of insulating layer 22a) preferably falls within the above range.

### Embodiment 6

In the present embodiment, the features unique to the present embodiment are mainly described, and description of the same features as in the above embodiments is not repeated here. On the common electrode 22 in Embodiment 5 are formed the insulating layers 22a at the positions superposed with the tips Ta of the projections T3 functioning as rivets, but not at the positions superposed with the side surfaces Tb of the projections T3 functioning as rivets. The common electrode in the present embodiment is provided with openings at the positions superposed with the tips of the projections functioning as rivets, but not at the positions superposed with the side surfaces of the projections functioning as rivets.

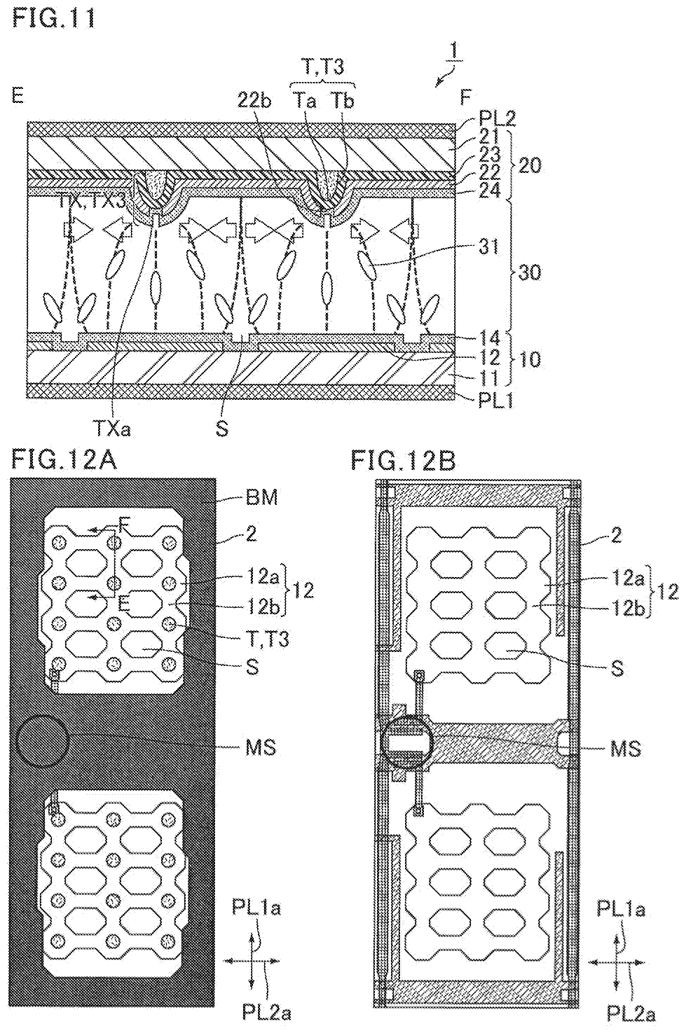

FIG. 11 is a schematic cross-sectional view of a liquid crystal display device of Embodiment 6. FIG. 12A is a schematic plan view of display units in the liquid crystal display device of Embodiment 6. FIG. 12B is a schematic plan view of the display units in the liquid crystal display device of Embodiment 6 with a focus on a first substrate. FIG. 11 is a schematic cross-sectional view taken along the line E-F in FIG. 12A. A MVA mode liquid crystal display device is described in the present embodiment.

The liquid crystal display device 1 of the present embodiment includes the first substrate 10, the second substrate 20 facing the first substrate 10, the vertical alignment-type liquid crystal layer 30 held between the first substrate 10 and the second substrate 20, and the display units 2 arranged in a matrix pattern in the display region.

The first substrate 10 includes, in the following order toward the liquid crystal layer 30, an insulating substrate, a transparent interlayer insulating film and the base coat layer 11, the pixel electrodes 12 each provided with the slits S, and the first alignment film 14. The second substrate 20 includes, in the following order toward the liquid crystal layer 30, an insulating substrate, the color filter layer 21, the projections T each having the tip Ta and the side surface Tb, the passivation film 23 covering the projections T, the common electrode 22 covering the passivation film 23, and the second alignment film 24. The portions surrounded by a circle in FIG. 12A and FIG. 12B indicate main spacers. The common electrode 22 is provided with the openings 22b at the positions superposed with the tips Ta of the projections T. The projections T, the passivation film 23, the common electrode 22, and the second alignment film 24 constitute the projection structures TX (TX3). Each projection structure TX has the surface TXa facing the first substrate 10. The surface TXa is not in contact with the first substrate 10 at the atmospheric pressure. The color filter layer 21 includes the black matrix BM formed in a substantially grid pattern and the CFs disposed inside the cells of the black matrix BM. The black matrix BM constitutes a light shielding region. The main spacers MS are dot-shaped and formed in the light shielding region.

Each pixel electrode 12 includes at least one point symmetrical part 12a. The projections T are dot-shaped and formed at the positions corresponding to the centers of the point symmetrical parts 12a. The projection structures TX including the respective projections T and the respective insulating layers 22a at the positions superposed with the tips Ta of the projections T are not in contact with the first substrate 10 at the atmospheric pressure.

The present embodiment employs the common electrode 22 covering the projections T each having the tip Ta and the side surface Tb, and the common electrode 22 is not provided with the openings at the positions superposed with the side surfaces Tb of the projections T. Between the projections T and the common electrode 22 is provided the passivation film 23 covering the projections T. Even in the case where the passivation film 23 is provided between the projections T and the common electrode 22, the passivation film 23 and the common electrode 22 conform to the shape of the projections T. This structure can enables effective generation of the oblique electric fields E near the side surfaces Tb of the projections T to tilt the liquid crystal molecules 31 near the side surfaces Tb of the projections T immediately after application of voltage (e.g., voltage giving a grayscale value of 240 or higher, with the voltage giving a grayscale value of 255 being defined as the white voltage), reducing the alignment disorder. This structure can increase the rise response speed of the liquid crystal molecules 31.

The common electrode 22 is provided with the openings 22b at the positions superposed with the tips Ta of the projections T. This structure can reduce the chances of contact between the common electrode 22 on the second substrate 20 and the pixel electrodes 12 on the first substrate 10 to reduce vertical leakage even when pressure is applied to the first substrate 10 and/or the second substrate 20 and the distance between the first substrate 10 and the second substrate 20 is reduced, for example.

The common electrode 22 is provided with the openings 22b at the positions superposed with the tips Ta of the projections T. The projection structures TX including the respective projections T are not in contact with the first substrate 10 at the atmospheric pressure. This structure can weaken the electric field intensity at the tips Ta of the projections T with voltage applied and make the liquid crystal molecules 31 less likely to tilt, reducing the size of disclination regions at the tips Ta of the projections T.

Each opening 22b has the same planar shape as the projections T functioning as rivets. The opening 22b is formed inside a region where a projection T is formed in a plan view.

Each opening 22b in a plan view preferably has a diameter of 2 μm to 20 μm, more preferably 2 μm to 12 μm. Too large a diameter of the opening 22b decreases the aperture ratio of the liquid crystal display device 1. Hence, the diameter of the opening 22b preferably falls within the above range. In the case where there is a plurality of the openings 22b, the openings 22b in a plan view may have the same diameter as each other or one or more of the openings 22b may have a different diameter from the others. The diameter of the opening in a plan view is also simply referred to as “the diameter of the opening”.

The diameter of the bottom surface of each projection T and the diameter of the corresponding opening 22b at the position superposed with the tip Ta of the projection T (diameter of bottom surface of projection T):(diameter of opening 22b) preferably satisfy a ratio of 1:0.1 to 1:0.6, more preferably a ratio of 1:0.1 to 1:0.4. A smaller diameter of the opening 22b relative to the diameter of the bottom surface of the projection T can more effectively generate electric fields, which move the liquid crystal molecules. Yet, too small a diameter of the bottom surface of the projection T may lead to ineffective reduction of vertical leakage. Thus, the ratio (diameter of bottom surface of projection T):(diameter of opening 22b) preferably falls within the above range.

### Embodiment 7

In the present embodiment, the features unique to the present embodiment are mainly described, and description of the same features as in the above embodiments is not repeated here. Although the case where the projections function as main spacers is described in Embodiment 3, the case where the projections function as sub spacers is described in the present embodiment.

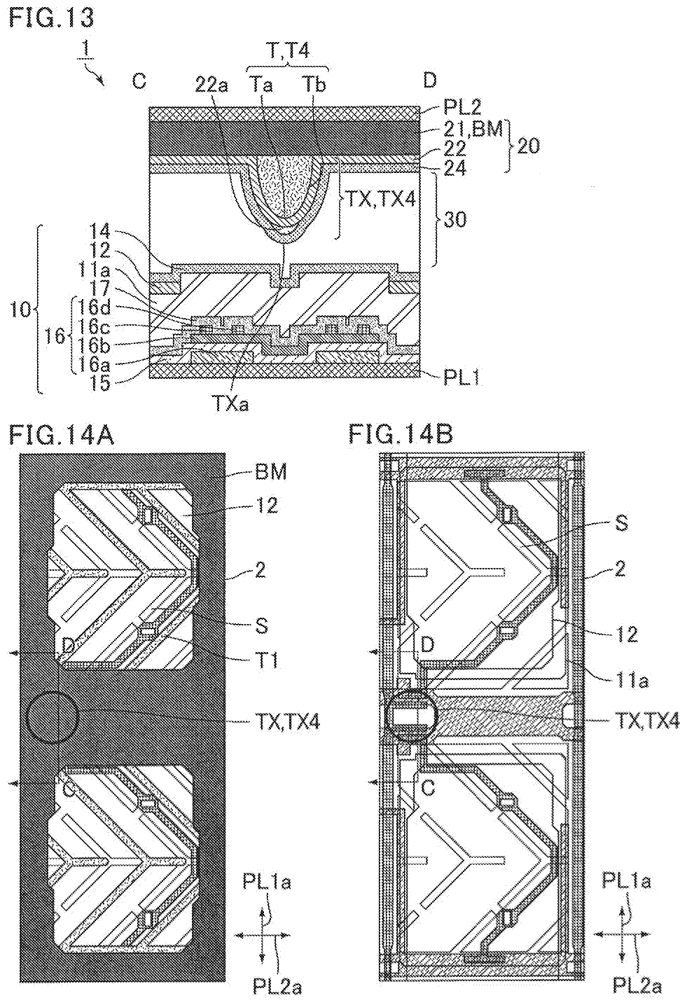

FIG. 13 is a schematic cross-sectional view of a liquid crystal display device of Embodiment 7. FIG. 14A is a schematic plan view of display units in the liquid crystal display device of Embodiment 7. FIG. 14B is a schematic plan view of the display units in the liquid crystal display device of Embodiment 7 with a focus on a first substrate. FIG. 13 is a schematic cross-sectional view taken along the line C-D in FIG. 14A. FIG. 14B also shows the line C-D to clarify the position of the line C-D in the first substrate. A MVA mode liquid crystal display device is described in the present embodiment.

The liquid crystal display device 1 of the present embodiment includes the first substrate 10, the second substrate 20 facing the first substrate 10, the vertical alignment-type liquid crystal layer 30 held between the first substrate 10 and the second substrate 20, and the display units 2 arranged in a matrix pattern in the display region.

The first substrate 10 includes, in the following order toward the liquid crystal layer 30, an insulating substrate, the gate electrodes 16a, the gate insulator 15, the thin film semiconductor layers 16b, the drain electrodes 16c and the source electrodes 16d, the passivation film 17, the transparent insulating film 11a, the pixel electrodes 12 each provided with the slits S, and the first alignment film 14. Each of the gate electrodes 16a, the corresponding thin film semiconductor layer 16b, the corresponding drain electrode 16c, and the corresponding source electrode 16d constitute a thin film transistor 16.

The second substrate 20 includes, in the following order toward the liquid crystal layer 30, an insulating substrate, the color filter layer 21, the projections T each having the tip Ta and the side surface Tb, the common electrode 22 covering the projections T, and the second alignment film 24. On the common electrode 22 are formed the insulating layers 22a at the positions superposed with the tips Ta of the projections T. The projections T, the common electrode 22, the insulating layers 22a, and the second alignment film 24 constitute the projection structures TX. Each projection structure TX has the surface TXa facing the first substrate 10. The surface TXa is not in contact with the first substrate 10 at the atmospheric pressure. In the present embodiment in which the projections T function as sub spacers, the projection structures TX are also referred to as projection structures TX4. The projections T in the present embodiment are projections T4 functioning as sub spacers that maintain the gap in which the liquid crystal layer 30 is formed. The color filter layer 21 includes the black matrix BM formed in a substantially grid pattern and the CFs disposed inside the cells of the black matrix BM. The black matrix BM constitutes a light shielding region. The projections T4 functioning as sub spacers are dot-shaped and formed in the light shielding region. The projections T4 functioning as sub spacers are not superposed with the pixel electrodes 12.

The liquid crystal display device 1 of the present embodiment includes the common electrode 22 covering the projections T each having the tip Ta and the side surface Tb, and no insulating layer is formed on the common electrode 22 at the positions superposed with the side surfaces Tb of the projections T. This structure enables effective generation of the oblique electric fields E near the side surfaces Tb of the projections T immediately after application of voltage (e.g., voltage giving a grayscale value of 240 or higher, with the voltage giving a grayscale value of 255 being defined as the white voltage), tilting the liquid crystal molecules 31 near the side surfaces Tb of the projections T. The projections T in the present embodiment are sub spacers and formed in the light shielding region. As the liquid crystal, molecules 31 in the light shielding region tilt immediately after application of voltage, the liquid crystal molecules 31 in the display region adjacent to the light shielding region become likely to tilt immediately after the application of voltage. This can increase the rise response speed of the liquid crystal molecules 31.

In the case where the projections T are sub spacers, the common electrode 22 at the positions superposed with the tips Ta of the projections T may come into contact with the TFT bus lines disposed on the counter substrate (first substrate 10) when pressure is applied to the first substrate 10 and/or the second substrate 20. Yet, since the insulating layers 22a are formed on the common electrode 22 at the positions superposed with the tips Ta of the projections T, the contact can be avoided, and thereby vertical leakage can be reduced.

On the common electrode 22 are formed the insulating layers 22a at the positions superposed with the tips Ta of the projections T. This structure can weaken the electric field intensity at the tips Ta of the projections T with voltage applied and make the liquid crystal molecules 31 less likely to tilt, reducing the size of disclination regions at the tips Ta of the projections T. This can reduce the light shielding region where the projections T functioning as sub spacers are arranged, thereby increasing the aperture ratio.

Each projection T has the tip Ta and the side surface Tb. The projection T has a shape tapering toward the tip Ta. The projection T has a cross-sectional shape such as a semicircular or trapezoidal shape in a plane perpendicular to a surface of the insulating substrate of the second substrate 20. In a cross-sectional view, the side surface Tb of the projection T is inclined from a surface of the insulating substrate of the second substrate 20, and preferably forms an angle of 40° to 90°, more preferably 50° to 80°, with the surface of the insulating substrate. The projections T may have the same shape as each other or one or more of the projections T may have a different shape from the others.

Each projection T functioning as a sub spacer preferably has a height (thickness) smaller than the height of a main spacer by 0.3 μm to 1.0 μm, more preferably 0.4 μm to 0.7 μm, still more preferably 0.45 μm to 0.65 μm.

The bottom surface of each projection T functioning as a sub spacer has a shape such as a circle, an ellipse, or a shape resembling an ellipse, including an oval with at least one symmetrical axis. The bottom surface of the projection T functioning as a sub spacer preferably has a shortest diameter of 10 μm to 60 μm, more preferably 20 μm to 50 μm.

Each insulating layer 22a has the same planar shape as the projections T functioning as sub spacers. The insulating layer 22a in a plan view is formed inside a region where a projection T is formed.

The insulating layer 22a preferably has a thickness of 0.1 μm to 1.5 μm, more preferably 0.2 μm to 1.2 μm, still more preferably 0.25 μm to 1.0 μm.

The height of each projection T functioning as a sub spacer and the thickness of the corresponding insulating layer 22a at the position superposed with the tip Ta of the projection T (height of projection T):(thickness of insulating layer 22a) preferably satisfy a ratio of 1:0.05 to 1:0.2, more preferably a ratio of 1:0.06 to 1:0.1. For more effective prevention of vertical leakage, the thickness of the insulating layer 22a is preferably 5% or more, more preferably 6% or more, of the height of the projection T. Also, for more effective generation of an electric field, which moves the liquid crystal molecules, the thickness of the insulating layer 22a is preferably small, and is preferably 20% or less, more preferably 10% or less, of the height of the projection T.

The bottom surface of the insulating layer 22a preferably has a shortest diameter of 5 μm to 20 μm, more preferably 8 μm to 16 μm.

The shortest diameter of the bottom surface of the projection T and the shortest diameter of the bottom surface of the insulating layer 22a at the position superposed with the tip Ta of the projection T (shortest diameter of bottom surface of projection T):(shortest diameter of bottom surface of insulating layer 22a) preferably satisfy a ratio of 1:0.05 to 1:0.9, more preferably a ratio of 1:0.06 to 1:0.32. A smaller shortest diameter of the bottom surface of the insulating layer 22a relative to the shortest diameter of the bottom surface of the projection T can more effectively generate electric fields, which move the liquid crystal molecules. Yet, too small a shortest diameter of the bottom surface of the insulating layer 22a relative to the shortest diameter of the bottom surface of the projection T may lead to ineffective reduction of vertical leakage. Thus, the ratio (shortest diameter of bottom surface of projection T):(shortest diameter of bottom surface of insulating layer 22a) preferably falls within the above range.

### Embodiment 8

In the present embodiment, the features unique to the present embodiment are mainly described, and description of the same features as in the above embodiments is not repeated here. On the common electrode in Embodiment 7 are formed the insulating layers 22a at the positions superposed with the tips Ta of the projections T4 functioning as sub spacers, but not at the positions superposed with the side surfaces Tb of the projections T4 functioning as sub spacers. The common electrode in the present embodiment is provided with openings at the positions superposed with the tips of the projections functioning as sub spacers, but not at the positions superposed with the side surfaces of the projections functioning as sub spacers.

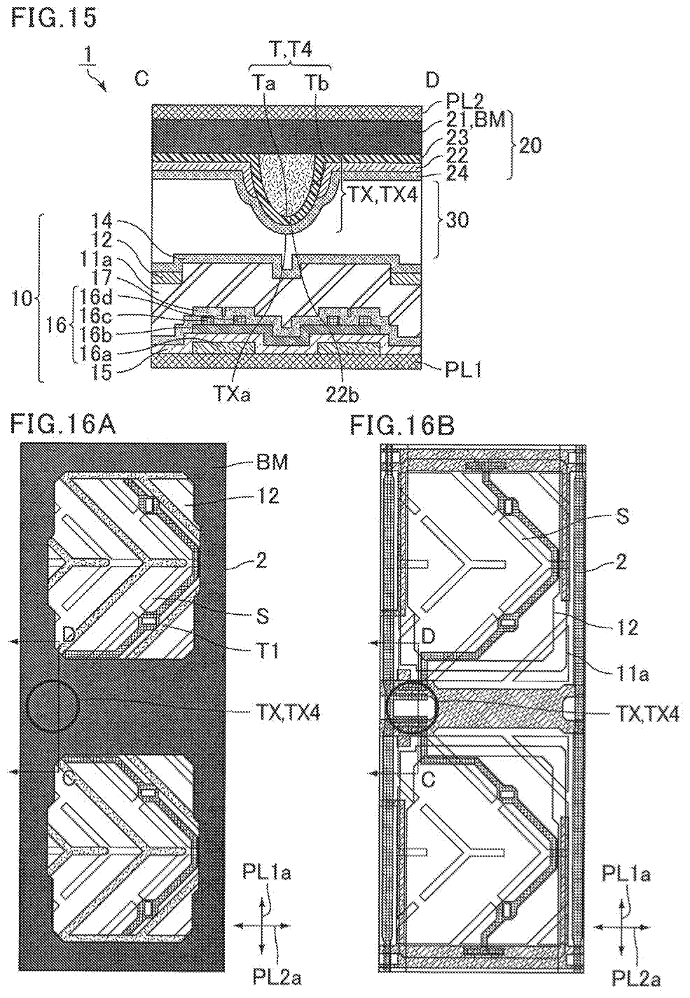

FIG. 15 is a schematic cross-sectional view of a liquid crystal display device of Embodiment 8. FIG. 16A is a schematic plan view of display units in the liquid crystal display device of Embodiment 8. FIG. 16B is a schematic plan view of the display units in the liquid crystal display device of Embodiment 8 with a focus on a first substrate. FIG. 15 is a schematic cross-sectional view taken along the line C-D in FIG. 16A. FIG. 16B also shows the line C-D to clarify the position of the line C-D in the first substrate. A MVA mode liquid crystal display device is described in the present embodiment.

The liquid crystal display device 1 of the present embodiment includes the first substrate 10, the second substrate 20 facing the first substrate 10, the vertical alignment-type liquid crystal layer 30 held between the first substrate 10 and the second substrate 20, and the display units 2 arranged in a matrix pattern in the display region.

The first substrate 10 includes, in the following order toward the liquid crystal layer 30, an insulating substrate, the gate electrodes 16a, the gate insulator 15, the thin film semiconductor layers 16b, the drain electrodes 16c and the source electrodes 16d, the passivation film 17, the transparent insulating film 11a, the pixel electrodes each provided with the slits S, and the first alignment film 14. Each of the gate electrodes 16a, the corresponding thin film semiconductor layer 16b, the corresponding drain electrode 16c, and the corresponding source electrode 16d constitute a thin film transistor 16.

The second substrate 20 includes, in the following order toward the liquid crystal layer 30, an insulating substrate, the color filter layer 21, the projections T each having the tip Ta and the side surface Tb, the passivation film 23 covering the projections T, the common electrode 22 covering the passivation film 23, and the second alignment film 24. The common electrode 22 is provided with the openings 22b at the positions superposed with the tips Ta of the projections T. The projections T, the passivation film 23, the common electrode 22, and the second alignment film 24 constitute the projection structures TX (TX4). Each projection structure TX has the surface TXa facing the first substrate 10. The surface TXa is not in contact with the first substrate 10 at the atmospheric pressure. The projections T in the present embodiment are the projections T4 functioning as sub spacers that maintain the gap in which the liquid crystal layer 30 is formed. The color filter layer 21 includes the black matrix BM formed in a substantially gird pattern and the CFs disposed inside the cells of the black matrix BM.

The present embodiment employs the common electrode 22 covering the projections T each having the tip Ta and the side surface Tb, and the common electrode 22 is not provided with openings at the positions superposed with the side surfaces Tb of the projections T. Between the projections T and the common electrode 22 is provided the passivation film 23 covering the projections T. Even in the case where the passivation film 23 is provided between the projections T and the common electrode 22, the passivation film 23 and the common electrode 22 conform to the shape of the projections T. This structure enables effective generation of the oblique elastic fields E near the side surfaces Tb of the projections T to tilt the liquid crystal molecules 31 near the side surfaces Tb of the projections T immediately after application of voltage (e.g., white voltage), reducing the alignment disorder. This can increase the rise response speed of the liquid crystal molecules 31.

In the case where the projections T are sub spacers, the common electrode 22 at the positions superposed with the tips Ta of the projections T may come into contact with the TFT bus lines disposed on the counter substrate (first substrate 10) when pressure is applied to the first substrate 10 and/or the second substrate 20. Yet, since the common electrode 22 is provided with the openings 22b at the positions superposed with the tips Ta of the projections T, the contact can be avoided, and thereby vertical leakage can be reduced.

The common electrode 22 is provided with the openings 22b at the positions superposed with the tips Ta of the projections T. This structure can weaken the electric field intensity at the tips Ta of the projections T with voltage applied and make the liquid crystal molecules 31 less likely to tilt, reducing the size of disclination regions at the tips Ta of the projections T. This can reduce the light shielding region where the projections T functioning as sub spacers are arranged, thereby increasing the aperture ratio.

Each opening 22b has the same planar shape as the projections T functioning as sub spacers. The opening 22b is formed inside a region where a projection T is formed in a plan view.

In a plan view, each opening 22b preferably has a shortest diameter of 5 μm to 20 μm, more preferably 8 μm to 16 μm.

The shortest diameter of the bottom surface of each projection T and the shortest diameter of the corresponding opening 22b at the position superposed with the tip Ta of the projection T (shortest diameter of bottom surface of projection T):(shortest diameter of opening 22b) preferably satisfy a ratio of 1:0.05 to 1:0.4, more preferably a ratio of 1:0.06 to 1:0.32. A smaller shortest diameter of the opening 22b relative to the shortest diameter of the bottom surface of the projection T can more effectively generate electric fields, which move the liquid crystal molecules. Yet, too small a shortest diameter of the opening 22b relative to the shortest diameter of the bottom surface of the projection T may lead to insufficient reduction of vertical leakage. Thus, the ratio (shortest diameter of bottom surface of projection T):(shortest diameter of opening 22b) preferably falls within the above range.

For further reduction of vertical leakage, the area of the opening 22b in a plan view is preferably ⅓ or more of the bottom surface area of the projection T.

### Modified Embodiment 1

The liquid crystal display device 1 including the insulating layers 22a at the tips Ta of the projections T1 functioning as ribs is described in Embodiment 1. The liquid crystal display device 1 provided with openings 22b at the tips Ta of the projections T1 functioning as ribs is described in Embodiment 2. The liquid crystal display device 1 including the insulating layers 22a at the tips Ta of the projections T2 functioning as main spacers is described in Embodiment 3. The liquid crystal display device 1 provided with the openings 22b at the tips Ta of the projections T2 functioning as main spacers is described in Embodiment 4. The liquid crystal display device 1 including the insulating layers 22a at the tips Ta of the projections T3 functioning as rivets is described in Embodiment 5. The liquid crystal display device 1 provided with the openings 22b at the tips Ta of the projections T3 functioning as rivets is described in Embodiment 6. The liquid crystal display device 1 including the insulating layers 22a at the tips Ta of the projections T4 functioning as sub spacers is described in Embodiment 7. The liquid crystal display device 1 provided with the openings 22b at the tips Ta of the projections T4 functioning as sub spacers is described in Embodiment 8. A liquid crystal display device may be obtained by appropriately combining these embodiments. For example, a liquid crystal display device such as a liquid crystal display device with the ribs in Embodiment 1 and the main spacers in Embodiment 3 or a liquid crystal display device with the main spacers in Embodiment 3 and the rivets in Embodiment 5 may be obtained by combining the embodiments in which the insulating layers 22a are formed at the tips Ta of the projections T. Also, a liquid crystal display device such as a liquid crystal display device with the ribs in Embodiments 1 and 2 or a liquid crystal display device with the ribs in Embodiments 1 and 2 and the main spacers in Embodiments 3 and 4 may be obtained by combining the embodiments in which the insulating layers 22a are formed at the tips Ta of the projections T and the embodiment in which the openings 22b are provided at the tips Ta of the projections T.

### Modified Embodiment 2

The transmissive liquid crystal display devices including the first polarizing plate PL1 on the side remote from the liquid crystal layer 30 of the first substrate 10 and the second polarizing plate PL2 on the side remote from the liquid crystal layer 30 of the second substrate 20 are described in Embodiments 1 to 8. Yet, the liquid crystal display devices may be reflective liquid crystal display devices 1 including the second polarizing plate PL2 on the side remote from the liquid crystal layer 30 of the second substrate 20 and no first polarizing plate PL1 on the side remote from the liquid crystal layer 30 of the first substrate 10.

The present invention is described in more detail based on the following examples and comparative example. The examples, however, are not intended to limit the scope of the present invention.

### Example 1

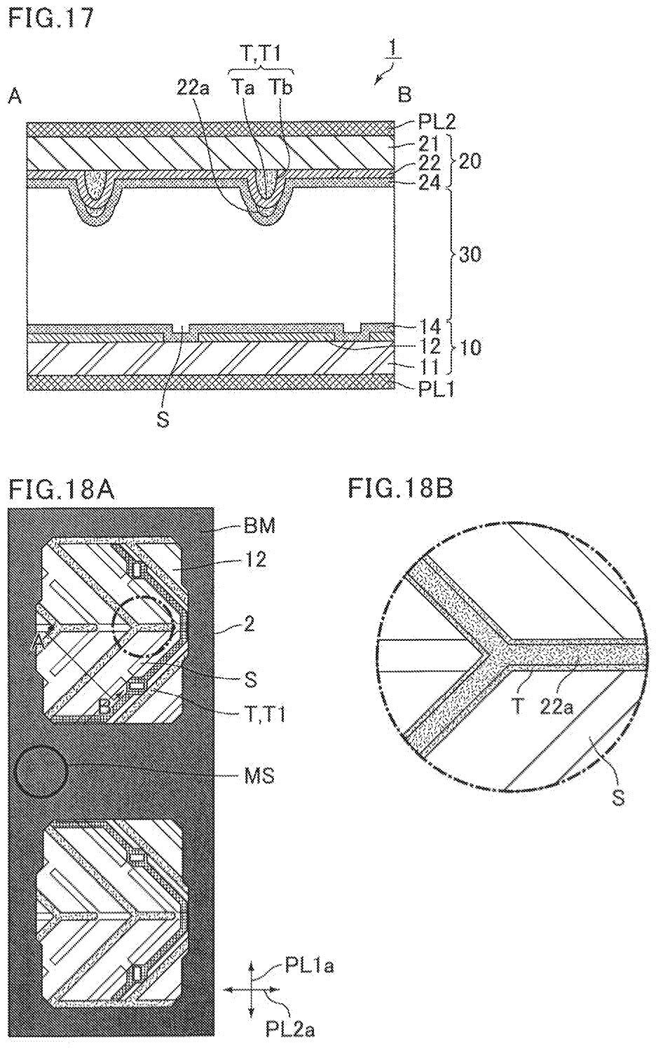

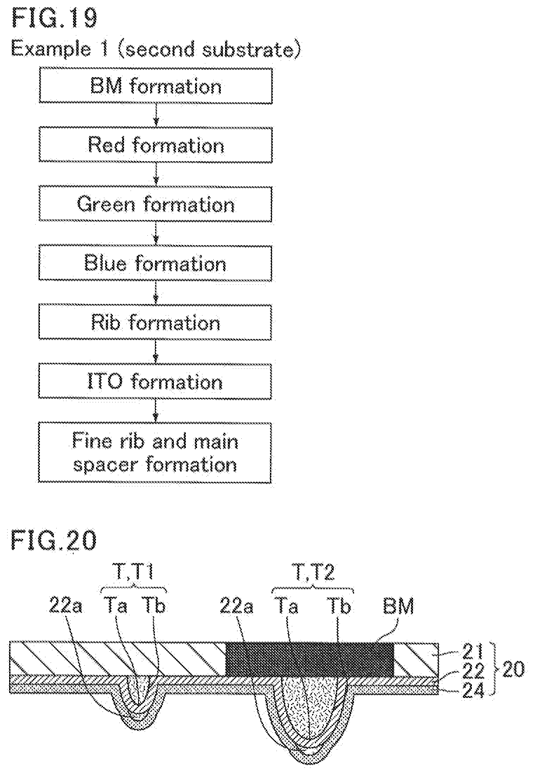

FIG. 17 is a schematic cross-sectional view of a liquid crystal display device of Example 1. FIG. 18A is a schematic plan view of display units in the liquid crystal display device of Example 1. FIG. 188B is an enlarged schematic plan view of the display units in the liquid crystal display device of Example 1, showing the region surrounded by the dashed-dotted circle in FIG. 18A. FIG. 17 is a schematic cross-sectional view taken along the line A-B in FIG. 18A. FIG. 19 is a flowchart showing the production process of a second substrate in the liquid crystal display device of Example 1. A liquid crystal display device 1 of Example 1 shown in FIG. 17, FIG. 18A, and FIG. 18B was produced following the flowchart in FIG. 19 by the method describe below.

A black matrix (BM) was formed in a grid pattern on an insulating substrate (not shown). Red color filters (Red), green color filters (Green), and blue color filters (Blue) were sequentially formed in the cells of the black matrix in the grid pattern, so that the color filter layer 21 was provided.

To the color filter layer 21 was applied a negative resist. The negative resist was patterned by photolithography to form the projections T1 (T) functioning as ribs. The projections T1 each had a height of 1.2 μm and a width of 11 μm. A film of ITO was formed by sputtering to cover the projections TI, so that the common electrode 22 was formed. The common electrode 22 had a thickness of 140 nm.

A negative resist was applied to the common electrode 22 and then patterned by photolithography using a halftone mask, whereby the insulating layers 22a at the positions superposed with the tips Ta of the projections T1 and the main spacers were formed. Each insulating layer 22a had a thickness of 0.2 μm and a width of 10 μm. The main spacer was not covered with the common electrode or the insulating layer. The main spacers each had a height of 3.55 μm, and the bottom surface thereof had a diameter of 45 μm. Thereby, the second substrate 20 was produced.

The first substrate 10 was produced as follows. A transparent interlayer insulating layer and the base coat layer 11 were formed on an insulating substrate (not shown). A film of ITO was formed by sputtering to cover the transparent interlayer insulating film and the base coat layer 11 and then etched by photolithography, so that the pixel electrodes 12 were formed. The pixel electrodes 12 were each provided with the slits S. The pixel electrodes 12 each had a thickness of 70 nm. Thereby, the first substrate 10 was produced.

Vertical alignment films (first alignment film 14 and second alignment film 24) were respectively formed on the first substrate 10 and the second substrate 20 produced as described above by printing. The liquid crystal layer 30 was formed by one-drop filling where a liquid crystal material was dropped onto one of the substrates and the substrates were bonded to each other in a vacuum. The first polarizing plate PL1 was formed on the side remote from the liquid crystal layer 30 of the first substrate 10 and the second polarizing plate PL2 was formed on the side remote from the liquid crystal layer 30 of the second substrate 20 such that they were in crossed Nicols. Thereby, the liquid crystal display device 1 of Example 1 was produced. In the liquid crystal display device 1 of Example 1, in a plan view, the slits S in the pixel electrodes 12 in the first substrate 10 were each formed between the projections T1 on the second substrate 20. The extension direction of the slits S and the projections T1 was at 45° from the polarization axes of the first polarizing plate PL1 and the second polarizing plate PL2.

### Comparative Example

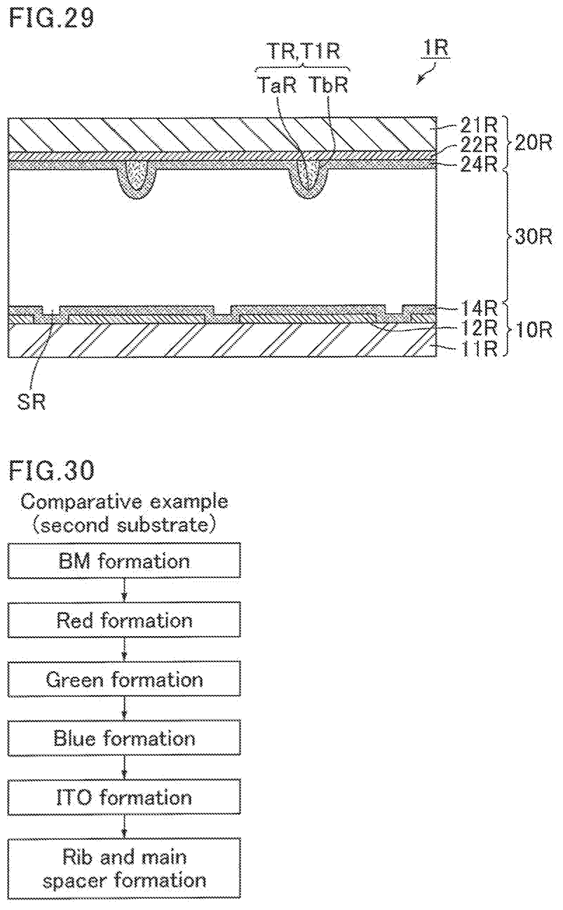

FIG. 29 is a schematic cross-sectional view of the liquid crystal display device of the comparative example. FIG. 30 is a flowchart showing the production process of a second substrate in the liquid crystal display device of the comparative example. A liquid crystal display device 1R of the comparative example was produced as with the liquid crystal display device 1 of Example 1, except that ribs and main spacers were formed after formation of the common electrode and that no insulating layer was formed. In other words, the liquid crystal display device 1R of the comparative example included the first substrate 10R, the liquid crystal layer 30R, and the second substrate 20R in the given order. The first substrate 10R included, in the following order toward the liquid crystal layer 30R, an insulating substrate (not shown), a transparent interlayer insulating film and the base coat layer 11R, the pixel electrodes 12 each provided with the slits SR, and the first alignment film 14R. The second substrate 20R included, in the following order toward the liquid crystal layer 30, an insulating substrate (not shown), the color filter layer 21R, the common electrode 22R, the projections T1R, and the second alignment film 24.

### Example 2

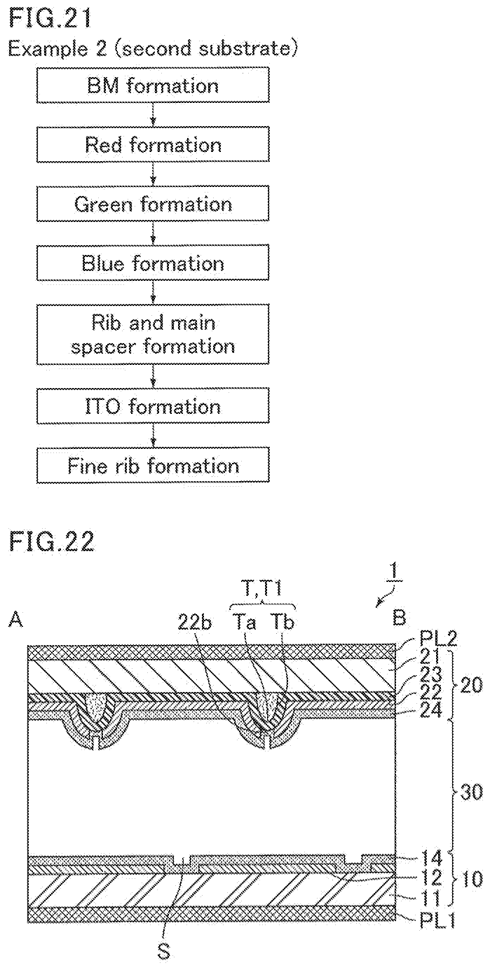

FIG. 20 is a schematic cross-sectional view of a second substrate in a liquid crystal display device of Example 2. FIG. 21 is a flowchart showing the production process of the second substrate in the liquid crystal display device of Example 2. In Example 1, the projections T1 functioning as ribs were formed. In Example 2, projections functioning as ribs and projections functioning as main spacers were formed.

A liquid crystal display device 1 of Example 2 was produced as in Example 1, except that the projections T2 (T) functioning as main spacers were not formed in the fine rib formation but formed simultaneously with the projections T1 functioning as ribs in the formation of the projections T1 functioning as ribs. Specifically, the projections T1 functioning as ribs were formed on the color filters of the color filter layer 21 by applying a negative resist to the color filter layer 21 and patterning the resist by photolithography using a halftone mask. Simultaneously, the projections T2 functioning as main spacers were formed on the black matrix BM of the color filter layer 21. The first substrate was produced such that its portions facing the projections T1 functioning as ribs were in the same state as in Embodiment 1 and its portions facing the projections T2 functioning as main spacers were in the same state as in Embodiment 3. Although the ribs and the main spacers were collectively formed using a halftone mask in the present example, a process may also be possible in which the main spacers are formed and a resist for formation of ribs is applied to the entire surface, followed by stacking of the main spacers on the resist and simultaneous exposure and development of the ribs.

The projections T1 functioning as ribs each had a height of 1.2 μm and a width of 11 μm. The projections T2 functioning as main spacers each had a height of 3.55 μm and the bottom surface thereof had a diameter of 45 μm. The insulating layers 22a at the tips of the projections T1 functioning as ribs each had a thickness of 0.2 μm and a width of 6 μm. The insulating layers 22a at the tips of the projections T2 functioning as main spacers each had a thickness of 0.2 μm and the bottom surface thereof had a dimeter of 10 μm.

### Example 3

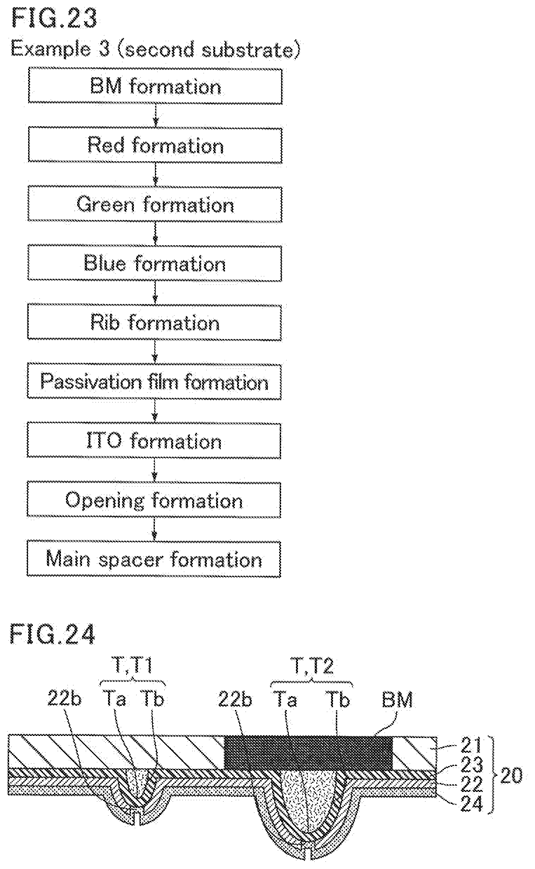

FIG. 22 is a schematic cross-sectional view of a liquid crystal display device of Example 3. FIG. 23 is a flowchart showing the production process of a second substrate in the liquid crystal display device of Example 3. In Example 1, the insulating layers 22a were formed on the common electrode 22. In Example 3, the common electrode 22 was provided with the openings 22b. The second substrate 20 of the liquid crystal display device of Example 3 was produced as in Example 1 up to the formation of the projections T1 functioning as ribs. Production of the first substrate 10 and bonding of the first substrate 10 and the second substrate 20 to form the liquid crystal display device 1 were the same as in Example 1. The following describes in detail the processes after formation of the projections T1 functioning as ribs in production of the second substrate 20.

After formation of the projections T1 functioning as ribs on the color filter layer 21, the passivation film 23 containing silicon nitride and having a thickness of 150 nm was formed to cover the color filter layer 21 and the projections T1. A film of ITO was formed by sputtering to cover the passivation film 23, whereby the common electrode 22 was formed. The common electrode 22 had a thickness of 140 nm.

A negative resist was applied to the common electrode 22, patterned by photolithography, and etched using oxalic acid, so that the openings (fine slits) 22b were formed at the positions superposed with the tips Ta of the projections T1. The projections T1 functioning as ribs each had a height of 1.2 μm and a width of 11 μm. The openings 22b each had a width of 4 μm.

A negative resist was applied to the second substrate 20 provided with the openings 22b and patterned by photolithography, so that main spacers were formed. The main spacers were not covered with the common electrode or the insulating layer. The main spacers each had a height of 3.55 μm and the bottom surface thereof had a diameter of 45 μm.

### Example 4

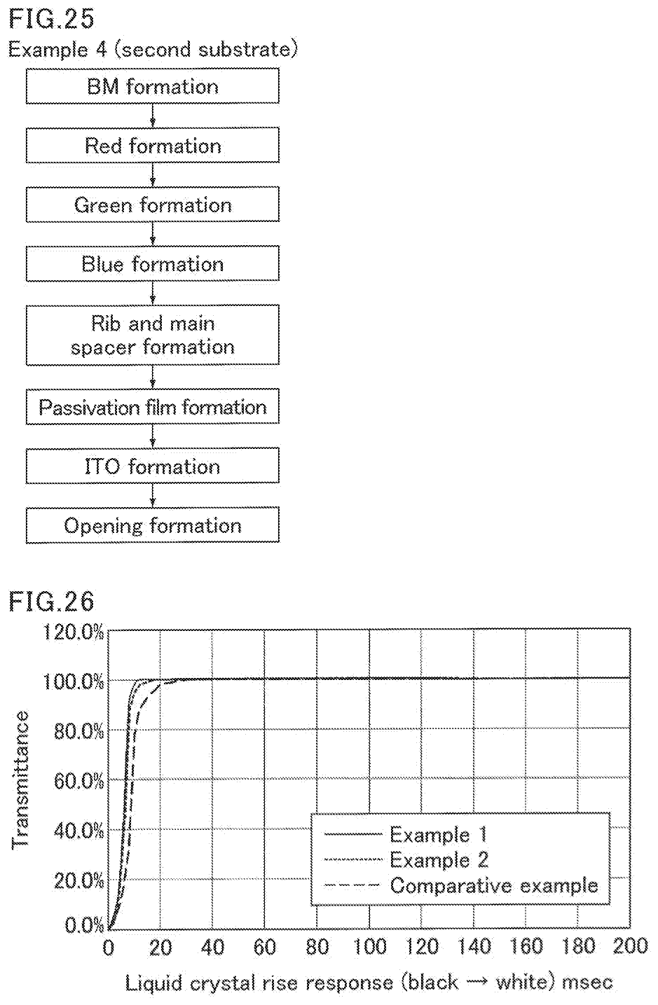

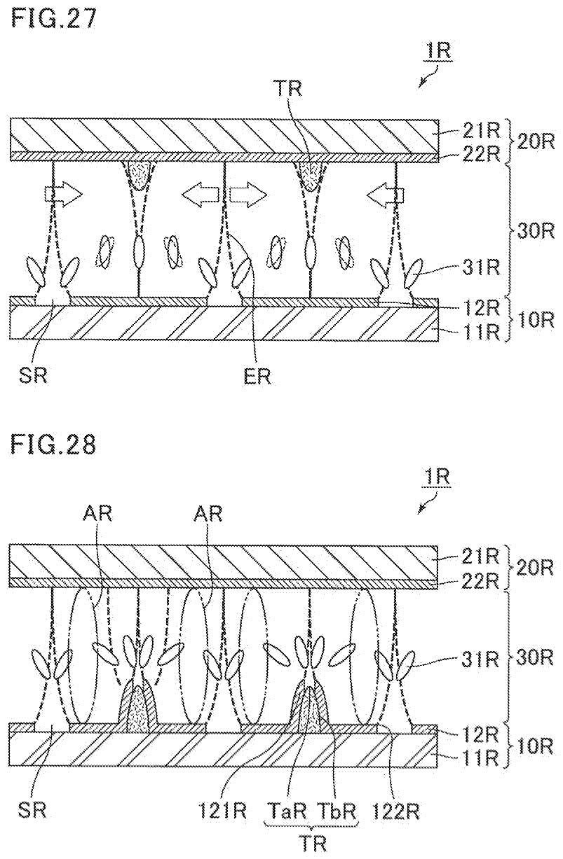

FIG. 24 is a schematic cross-sectional view of a second substrate in a liquid crystal display device of Example 4. FIG. 25 is a flowchart showing the production process of the second substrate in the liquid crystal display device of Example 4. In Example 2, the insulating layers 22a were formed on the common electrode 22 at the positions superposed with the tips Ta of the projections T (T1 and T2). In Example 4, the common electrode 22 was provided with the openings 22b. The second substrate 20 of the liquid crystal display device of Example 4 was produced as in Example 2 up to the formation of the projections T1 functioning as ribs and the projections T2 functioning as main spacers. Production of the first substrate 10 and bonding of the first substrate 10 and the second substrate 20 to form the liquid crystal display device 1 were the same as in Example 2. The following describes in detail the processes after formation of the projections T2 functioning as main spacers in production of the second substrate 20.

After formation of the projections T2 functioning as main spacers on the color filter layer 21, the passivation film 23 containing silicon nitride and having a thickness of 150 nm was formed to cover the color filter layer 21, the projections TI functioning as ribs, and the projections T2 functioning as main spacers. A film of ITO was formed by sputtering to cover the passivation film 23, whereby the common electrode 22 was formed. The common electrode 22 had a thickness of 140 nm.

A negative resist was applied to the common electrode 22, patterned by photolithography, and etched using oxalic acid, so that the openings (fine slits) 22b were formed at the positions superposed with the tips Ta of the projections T1 functioning as ribs and the projections T2 functioning as main spacers. The first substrate was produced such that its portions facing the projections T1 functioning as ribs were in the same state as in Embodiment 2 and its portions facing the projections T2 functioning as main spacers were in the same state as in Embodiment 4.

The projections T1 functioning as ribs each had a height of 1.2 μm and a width of 11 μm. The projections T2 functioning as main spacers each had a height of 3.55 μm and the bottom surface thereof had a diameter of 45 μm. The openings 22b provided at the tips of the projections T1 functioning as ribs each had a width of 4 μm. The openings 22b provided at the tips of the projections T2 functioning as spacers each had a diameter of 10 pmt.

### <Evaluation of Examples 1 and 2 and Comparative Example>

### (Evaluation on Rise Response Speed)

FIG. 26 is a graph showing rise responses of the liquid crystal display devices of Examples 1 and 2 and a comparative example. The rise response from black display to white display (black-white) of the liquid crystal display devices produced in Examples 1 and 2 and the comparative example were compared by plotting transmittance versus response speed. Here, the source voltage had a square waveform, the voltage giving black display was 0.1 Vrms, and the voltage giving white display was 8 Vrms. FIG. 26 shows the results. With a voltage of 6 Vrms or lower, no back flow of the liquid crystal molecules was observed, and there was no influence on the rise response speed. Case of the square waveform, rms (root mean square) is equal to the amplitude and Vrms is a unit of effective voltage.

FIG. 26 shows that the liquid crystal display devices 1 of both Examples 1 and 2 achieved a higher transmittance in a shorter time than the liquid crystal display device of the comparative example, achieving favorable rise response. In the liquid crystal display devices 1 of Examples 1 and 2, the electric fields around the projections T (T1 and T2) worked effectively in oblique directions and thus the liquid crystal molecules easily tilted in these regions. This is presumably how the favorable rise response was achieved.

### (Evaluation on Vertical Leakage)

In the case where vertical leakage was forcibly generated by pressing the screen (liquid crystal panel) with a finger, a line defect seems to occur around the leakage intersection. However, in Examples 1 and 2, such a defect did not occur even when the screen was pressed.

### (Evaluation 1 on Disclination)

In the case where the width of the disclination region becomes larger than expected, variation of disclination regions causes display unevenness such as roughness at intermediate grayscale values. However, in Examples 1 and 2, such a defect did not occur.

### (Evaluation 2 on Disclination)

At the white grayscale value, a portion pressed with a finger causes luminance unevenness. In the case where the width of the disclination region becomes larger than expected, it takes time for the luminance unevenness to disappear and the alignment is restored. However, in Examples 1 and 2, such a defect did not occur.

What is claimed is:

1. A liquid crystal display device comprising:
a first substrate;
a second substrate facing the first substrate; and
a vertical alignment-type liquid crystal layer held between the first substrate and the second substrate,
the first substrate including a pixel electrode,
the second substrate including a projection, a common electrode covering the projection, and an insulating layer on the common electrode,
the insulating layer superposed with a tip of the projection but not superposed with a side surface of the projection.

2. The liquid crystal display device according to claim 1,
wherein the insulating layer has a thickness of 0.1 μm to 1.5 μm.

3. A liquid crystal display device comprising:
a first substrate;
a second substrate facing the first substrate; and
a vertical alignment-type liquid crystal layer held between the first substrate and the second substrate,
the first substrate including a pixel electrode,
the second substrate including a projection and a common electrode covering a side surface of the projection but not covering a tip of the projection.

4. The liquid crystal display device according to claim 3,
wherein the second substrate further includes a passivation film covering the projection and disposed between the projection and the common electrode.

5. The liquid crystal display device according to claim 1,
wherein the projection is included in a projection structure, and the projection structure is not in contact with the first substrate at atmospheric pressure.

6. The liquid crystal display device according to claim 5, further comprising a polarizing plate on one or both of a side remote from the liquid crystal layer of the first substrate and a side remote from the liquid crystal layer of the second substrate,
wherein the projection extends in a belt shape in a direction intersecting a polarization axis of the polarizing plate.

7. The liquid crystal display device according to claim 5,
wherein the pixel electrode includes at least one point symmetrical part, and
the projection is dot-shaped and formed at a position facing a center of the point symmetrical part.

8. The liquid crystal display device according to claim 5,
wherein the projection structure is a sub spacer, and
the projection is dot-shaped and formed in a light-shielding region.

9. The liquid crystal display device according to claim 3,
wherein the projection is included in a projection structure, and the projection structure is not in contact with the first substrate at atmospheric pressure.

10. The liquid crystal display device according to claim 9, further comprising a polarizing plate on one or both of a side remote from the liquid crystal layer of the first substrate and a side remote from the liquid crystal layer of the second substrate,
wherein the projection extends in a belt shape in a direction intersecting a polarization axis of the polarizing plate.

11. The liquid crystal, display device according to claim 9,
wherein the pixel electrode includes at least one point symmetrical part, and
the projection is dot-shaped and formed at a position facing a center of the point symmetrical part.

12. The liquid crystal display device according to claim 9,
wherein the projection structure is a sub spacer, and
the projection is dot-shaped and formed in a light-shielding region.

13. The liquid crystal display device according to claim 1,
wherein the projection is included in a projection structure, and the projection structure is in contact with the first substrate at atmospheric pressure.

14. The liquid crystal display device according to claim 13,
wherein the projection structure is a main spacer, and
the projection is dot-shaped and formed in a light-shielding region.

15. The liquid crystal display device according to claim 3,
wherein the projection is included in a projection structure, and the projection structure is in contact with the first substrate at atmospheric pressure.

16. The liquid crystal display device according to claim 15,
wherein the projection structure is a main spacer, and
the projection is dot-shaped and formed in a light-shielding region.
